(19) United States
(12) Patent Application Publication
(10) Pub. No.: US 2015/0271502 A1
(43) Pub. Date: Sep. 24, 2015

(54) VIDEO ENCODING DEVICE, VIDEO DECODING DEVICE, VIDEO ENCODING METHOD, AND VIDEO DECODING METHOD

(71) Applicant: Mitsubishi Electric Corporation, Tokyo (JP)

(72) Inventors: Ryoji Hattori, Tokyo (JP); Kazuo Sugimoto, Tokyo (JP); Akira Minezawa, Tokyo (JP); Shunichi Sekiguchi, Tokyo (JP); Norimichi Hiwasa, Tokyo (JP); Yoshimi Moriya, Tokyo (JP)

(73) Assignee: MITSUBISHI ELECTRIC CORPORATION, TOKYO (JP)

(21) Appl. No.: 14/432,168

(22) PCT Filed: Sep. 27, 2013
(86) PCT No.: PCT/JP2013/076340

§ 371 Date: Mar. 27, 2015

(30) Foreign Application Priority Data
Sep. 28, 2012 (JP) 2012-217089

(51) Int. Cl. H04N 19/139; H04N 19/52; H04N 19/105; H04N 19/91; H04N 19/513; H04N 19/172

(52) U.S. Cl. CPC H04N 19/139; H04N 19/521; H04N 19/172; H04N 19/105; H04N 19/91; H04N 19/52

(57) ABSTRACT

A motion-compensated prediction unit 6 is configured in such a way as to, when the coding unit of a coding target picture differs from that of a reference picture, correct a reference vector held by a reference picture and derive a prediction vector from the corrected reference vector. As a result, application to the HEVC can be achieved even when the encoding based on a per frame basis and the encoding based on a per field basis coexist.

### FIELD OF THE INVENTION

The present invention relates to a video encoding device for and a video encoding method of encoding a video with a high degree of efficiency, and a video decoding device for and a video decoding method of decoding an encoded video with a high degree of efficiency.

### BACKGROUND OF THE INVENTION

Video data which a video encoding device handles have two types of formats, the interlaced format and the progressive format.

When each unit which constructs a video is called a frame, the structure of the frame differs between the interlaced format and the progressive format.

FIG. 3 is an explanatory drawing showing the structure of a frame having the progressive format, and FIG. 4 is an explanatory drawing showing the structure of a frame having the interlaced format.

In the progressive format, as shown in FIG. 3, all the pixels in each frame are captured at the same time T.

In contrast, the interlaced format is configured in such a way that the acquisition time differs between even lines and odd lines, as shown in FIG. 4.

Concretely, when the difference in capture/display time between frames is “1”, the even lines are captured at a time τ, and the odd lines are captured at a time (τ+0.5).

Hereafter, the even lines in each frame having the interlaced format are referred to as “top field”, and the odd lines are referred to as “bottom field.”

In the encoding of a video having the interlaced format, there are a method of encoding the video on a per frame basis, and a method of encoding the video on a per field basis.

The method of encoding the video on a per frame basis is a method of encoding each frame in which the top field and the bottom field are alternately arranged in the even and odd lines, respectively, as a picture which is a coding unit.

The method of encoding the video on a per field basis is a method of encoding the video by assuming that the top field and the bottom field are individual pictures.

When a video content in which a frame for which the encoding based on a per frame basis is suitable, and a frame for which the encoding based on a per field basis is suitable coexist is assumed, it is judged that the coding efficiency can be improved if switching between both the encoding methods can be performed adaptively.

However, when the encoding based on a per frame basis and the encoding based on a per field basis are made to coexist, there may occur a situation in which the coding unit differs between the current picture which is the picture to be encoded, and a reference picture.

When there occurs a situation in which the coding unit differs between the current picture and a reference picture, a process of matching the format of the reference picture to that of the current picture is needed.

In the next-generation video encoding method HEVC (High Efficiency Video Coding) for which the standardization is scheduled to be completed in 2013, a process using a time prediction vector is used as a process of making not only inter-frame reference to a pixel value, but also inter-frame reference to a motion vector (refer to nonpatent reference 1).

A time prediction vector uses a correlation in a temporal direction of motion information, and there is provided an advantage of reducing the amount of information of the motion vector.

A method of deriving a time motion vector in the HEVC is performed as follows.

In the HEVC, in order to determine a time prediction vector, motion vector information (reference vector) is held for each reference picture.

In a process of encoding a certain block in the current picture, when determining a time prediction vector, a reference vector at a specific position which pairs up with a reference picture and is held is determined as a prediction vector according to the semantics of decoding.

A reference vector for each reference picture is held in a configuration in which the reference picture is partitioned into blocks (reference vector blocks), in a grid form, each having a specific size, and one reference vector is provided for each of the reference vector blocks.

### RELATED ART DOCUMENT

### Nonpatent reference

Nonpatent reference 1: Benjamin Bross, Woo-Jin Han, Jens-Rainer Ohm, Gary J. Sullivan, Thomas Wiegand, “High efficiency video coding (HEVC) text specification draft 8”, JCTVC-J1003, Joint Collaborative Team on Video Coding (JCT-VC) of ITU-T SG16 WP3 and ISO/IEC JTC1/SC29/WG11 10th Meeting: Stockholm, SE,11-20 Jul. 2012

### SUMMARY OF THE INVENTION

### Problems to be Solved by the Invention

Because the conventional video encoding device is constructed as mentioned above, when applying a method of adaptively switching between the encoding based on a per frame basis and the encoding based on a per field basis to the HEVC, it is necessary to prepare a special structure of deriving a time prediction vector from a reference vector. More specifically, because the size and the position in space coordinates of a picture, which is a coding unit, differ between the encoding based on a per frame basis and the encoding based on a per field basis, a structure of matching the position of the reference vector to be referred to when deriving a time prediction vector is needed when the coding unit (coding unit which is a frame or field) differs between the current picture and the reference picture.

A problem with the conventional video encoding device is, however, that because no structure of matching the position of the reference vector to be referred to when deriving a time prediction vector is disposed, the video encoding device cannot be applied to the HEVC when the encoding based on a per frame basis and the encoding based on a per field basis coexist.

The present invention is made in order to solve the above-mentioned problems, and it is therefore an object of the present invention to provide a video encoding device, a video decoding device, a video encoding method, and a video decoding method which can be applied to the HEVC even when the encoding based on a per frame basis and the encoding based on a per field basis coexist.

### Means for Solving the Problem

In accordance with the present invention, there is provided a video encoding device including: a prediction image generator that derives a prediction vector from a reference vector held by a reference picture, and also searches for a motion vector by using the prediction vector and performs a motion-compensated prediction process on a coding target picture by using the motion vector, to generate a prediction image, in which when the coding unit of the coding target picture differs from that of the reference picture, the prediction image generator corrects the reference vector held by the reference picture and derives the prediction vector from the corrected reference vector.

### Advantages of the Invention

In accordance with the present invention, because the video encoding device is configured in such a way as to, when the coding unit of the coding target picture differs from that of the reference picture, correct the reference vector held by the reference picture and derive the prediction vector from the corrected reference vector, there is provided an advantage of being able to achieve application to the HEVC even when the encoding based on a per frame basis and the encoding based on a per field basis coexist.

### BRIEF DESCRIPTION OF THE FIGURES

FIG. 1 is a block diagram showing a video encoding device in accordance with Embodiment 1 of the present invention;

FIG. 2 is a block diagram showing a video decoding device in accordance with Embodiment 1 of the present invention;

FIG. 3 is an explanatory drawing showing the structure of a frame having the progressive format;

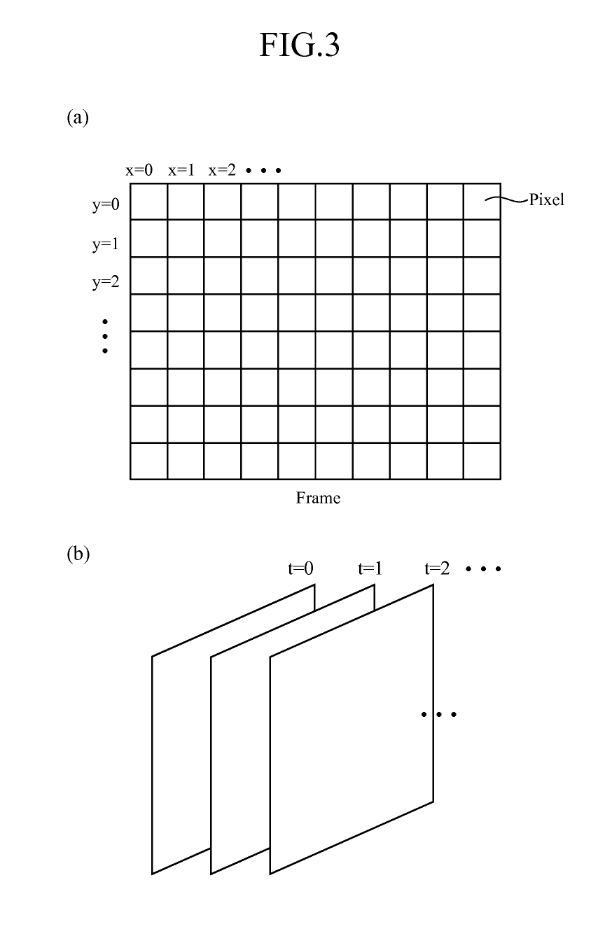

FIG. 4 is an explanatory drawing showing the structure of a frame having the interlaced format;

FIG. 5 is a flow chart showing processing (video encoding method) performed by the video encoding device in accordance with Embodiment 1 of the present invention;

FIG. 6 is an explanatory drawing showing an example in which each largest coding block is partitioned hierarchically into a plurality of coding target blocks;

FIG. 7(a) an explanatory drawing showing a distribution of partitions after partitioning, and FIG. 7(b) is an explanatory drawing showing a state in which coding modes m(Bⁿ) are assigned through hierarchical partitioning by using a quadtree graph;

FIG. 8 is a flow chart showing processing (video decoding method) performed by the video decoding device in accordance with Embodiment 1 of the present invention;

FIG. 9 is an explanatory drawing showing the data structure of a reference vector map;

FIG. 10 is an explanatory drawing regarding a process of deriving a time prediction vector when the encoding based on a per field basis and the encoding based on a per frame basis coexist;

FIG. 11 is an explanatory drawing showing a correspondence between reference vector blocks and partitions; and

FIG. 12 is an explanatory drawing showing reference vector maps for the top field and the bottom field.

### EMBODIMENTS OF THE INVENTION

Hereafter, in order to explain this invention in greater detail, the preferred embodiments of the present invention will be described with reference to the accompanying drawings.

### Embodiment 1

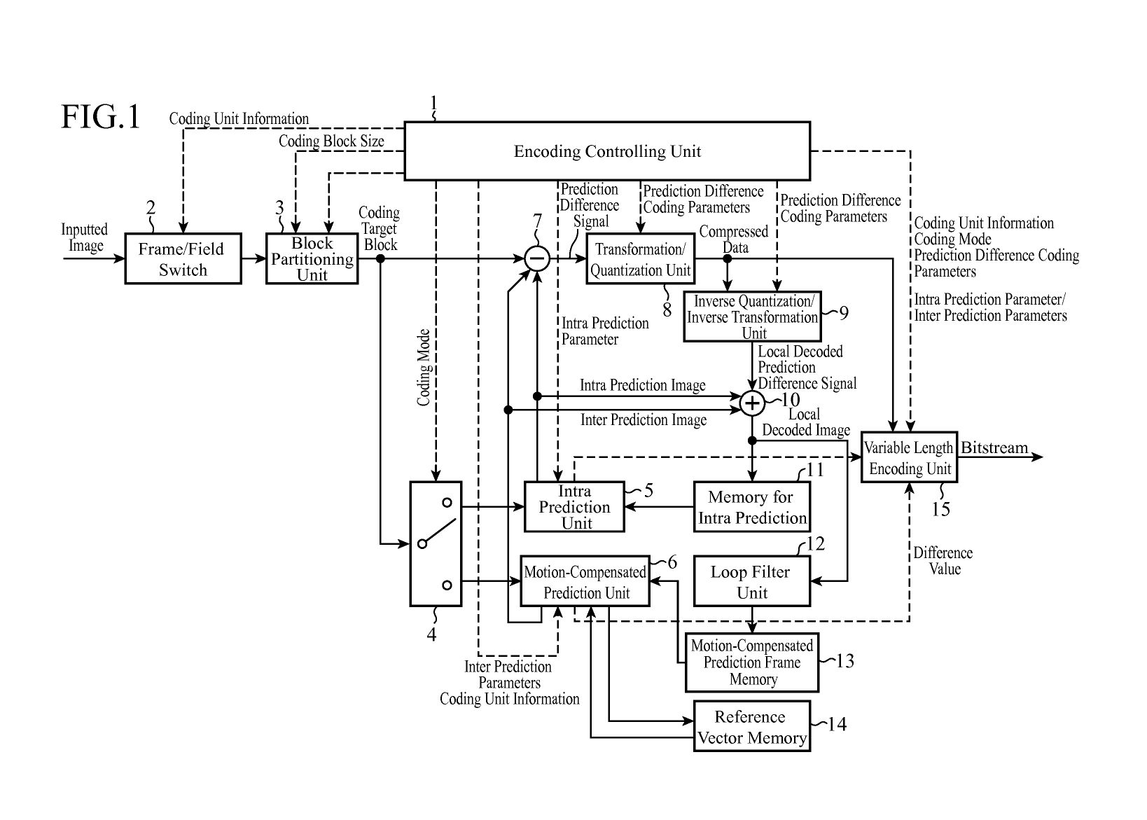

FIG. 1 is a block diagram showing a video encoding device in accordance with Embodiment 1 of the present invention.

Referring to FIG. 1, an encoding controlling unit 1 performs a process of, for each of frames which construct an inputted image, selecting either each frame or each field as a coding unit of the frame, and outputting coding unit information showing the coding unit to a frame/field switch 2, a motion-compensated prediction unit 6, and a variable length encoding unit 15.

The encoding controlling unit 1 also performs a process of determining a coding block size, and also determining a coding mode with the highest coding efficiency for a coding target block outputted from a block partitioning unit 3.

The encoding controlling unit 1 also performs a process of, when the coding mode with the highest coding efficiency is an intra coding mode, determining an intra prediction parameter which the video encoding device uses when performing an intra prediction process on the coding target block in the intra coding mode, and, when the coding mode with the highest coding efficiency is an inter coding mode, determining inter prediction parameters which the video encoding device uses when performing an inter prediction process on the coding target block in the inter coding mode.

The encoding controlling unit 1 further performs a process of determining prediction difference coding parameters which the encoding controlling unit provides for a transformation/quantization unit 8 and an inverse quantization/inverse transformation unit 9.

The encoding controlling unit 1 constructs a coding unit selector.

The frame/field switch 2 performs a process of, when receiving a video signal showing an inputted image, generating a current picture (coding target picture) having a size of the coding unit shown by the coding unit information outputted from the encoding controlling unit 1 from each frame in the inputted image.

For example, when the coding unit shown by the coding unit information outputted from the encoding controlling unit 1 is “each frame”, the frame/field switch outputs each frame to the block partitioning unit 3 without converting the format of each frame in the inputted image.

In contrast, when the coding unit shown by the coding unit information is “each field”, the frame/field switch generates a picture having a size of each field by changing the position of each pixel which constructs the inputted image, and outputs the picture to the block partitioning unit 3.

Although a case in which the frames which construct the inputted image are inputted one by one is assumed in this Embodiment 1, a case in which the fields which construct the inputted image are inputted one by one can also be assumed.

In this case, for example, when the coding unit shown by the coding unit information outputted from the encoding controlling unit 1 is “each field”, the frame/field switch outputs each field to the block partitioning unit 3 without converting the format of each field in the inputted image.

In contrast, when the coding unit shown by the coding unit information is “each frame”, the frame/field switch generates a picture having a size of each frame by changing the position of each pixel which constructs the inputted image, and outputs the picture to the block partitioning unit 3.

The frame/field switch 2 constructs a coding target picture generator.

The block partitioning unit 3 performs a process of partitioning the current picture generated by the frame/field switch 2 into blocks each having the coding block size determined by the encoding controlling unit 1 (blocks which are units for prediction process), and outputting each coding target block which is a unit for prediction process to a select switch 4 and a subtracting unit 7. The block partitioning unit 3 constructs a block partitioner.

The select switch 4 performs a process of, when the coding mode determined by the encoding controlling unit 1 is an intra coding mode, outputting the coding target block outputted from the block partitioning unit 3 to an intra prediction unit 5, and, when the coding mode determined by the encoding controlling unit 1 is an inter coding mode, outputting the coding target block outputted from the block partitioning unit 3 to the motion-compensated prediction unit 6.

The intra prediction unit 5 performs an intra prediction process on the coding target block outputted from the select switch 4 by using the intra prediction parameter determined by the encoding controlling unit 1 while referring to a local decoded image stored in a memory 11 for intra prediction, and performs a process of generating an intra prediction image.

The motion-compensated prediction unit 6 compares the coding target block outputted from the select switch 4 with one or more frames of local decoded images which are stored in a motion-compensated prediction frame memory 13, to search for a motion vector, and performs an inter prediction process (motion-compensated prediction process) on the coding target block by using both the motion vector and the inter prediction parameters determined by the encoding controlling unit 1 and performs a process of generating an inter prediction image.

Although when searching for a motion vector, the motion-compensated prediction unit 6 derives a prediction vector from a reference vector stored in a reference vector memory 14 (reference vector held by a reference picture) and searches for a motion vector by using the prediction vector (the details of this process will be mentioned later), when the coding unit of the current picture generated by the frame/field switch 2 differs from that of the reference picture, the motion-compensated prediction unit corrects the reference vector held by the reference picture and derives the prediction vector from the corrected reference vector.

A prediction image generator is comprised of the select switch 4, the motion-compensated prediction unit 6, the motion-compensated prediction frame memory 13, and the reference vector memory 14.

The subtracting unit 7 performs a process of subtracting either the intra prediction image generated by the intra prediction unit 5 or the inter prediction image generated by the motion-compensated prediction unit 6 from the coding target block outputted from the block partitioning unit 3, and outputting a prediction difference signal (difference image) which is the result of the subtraction to the transformation/quantization unit 8.

The transformation/quantization unit 8 refers to the prediction difference coding parameters determined by the encoding controlling unit 1, performs an orthogonal transformation process (e.g., an orthogonal transformation process such as a DCT (discrete cosine transform) or a KL transform in which bases are designed for a specific learning sequence in advance) on the prediction difference signal outputted from the subtracting unit 7, to calculate transform coefficients, and also refers to the prediction difference coding parameters and performs a process of quantizing the transform coefficients and outputting compressed data which are the transform coefficients quantized thereby (the quantization coefficients of the difference image) to the inverse quantization/inverse transformation unit 9 and the variable length encoding unit 15.

An image compressor is comprised of the subtracting unit 7 and the transformation/quantization unit 8.

The inverse quantization/inverse transformation unit 9 refers to the prediction difference coding parameters determined by the encoding controlling unit 1 and inverse-quantizes the compressed data outputted from the transformation/quantization unit 8, and also refers to the prediction difference coding parameters, and performs an inverse orthogonal transformation process on the transform coefficients which are the compressed data inverse-quantized thereby and performs a process of calculating a local decoded prediction difference signal corresponding to the prediction difference signal outputted from the subtracting unit 7.

An adding unit 10 performs a process of adding the local decoded prediction difference signal calculated by the inverse quantization/inverse transformation unit 9 and either the intra prediction image generated by the intra prediction unit 5 or the inter prediction image generated by the motion-compensated prediction unit 6, to calculate a local decoded image corresponding to the coding target block outputted from the block partitioning unit 3.

The memory 11 for intra prediction is a recording medium that stores the local decoded image calculated by the adding unit 10.

A loop filter unit 12 performs a predetermined filtering process on the local decoded image calculated by the adding unit 10, and performs a process of outputting the local decoded image filtering-processed thereby.

The motion-compensated prediction frame memory 13 is a recording medium that stores the local decoded image filtering-processed.

The reference vector memory 14 is a recording medium that stores a reference vector which is used for the derivation of a time prediction vector at the time of encoding the next picture.

The variable length encoding unit 15 performs a process of variable-length-encoding the compressed data outputted from the transformation/quantization unit 8, the output signal of the encoding controlling unit 1 (the coding unit information, the coding mode, the intra prediction parameter or the inter prediction parameters, and the prediction difference coding parameters), and the difference value between the motion vector and the prediction vector which are outputted from the motion-compensated prediction unit 6 (when the coding mode is an inter coding mode), to generate a bitstream.

The variable length encoding unit 15 constructs a variable length encoder.

In the example of FIG. 1, it is assumed that the encoding controlling unit 1, the frame/field switch 2, the block partitioning unit 3, the select switch 4, the intra prediction unit 5, the motion-compensated prediction unit 6, the subtracting unit 7, the transformation/quantization unit 8, the inverse quantization/inverse transformation unit 9, the adding unit 10, the memory 11 for intra prediction, the loop filter unit 12, the motion-compensated prediction frame memory 13, the reference vector memory 14, and the variable length encoding unit 15, which are the components of the video encoding device, consist of pieces of hardware for exclusive use (e.g., semiconductor integrated circuits in each of which a CPU is mounted, one chip microcomputers, or the like), respectively. As an alternative, the video encoding device can consist of a computer.

In the case in which the video encoding device consists of a computer, the memory 11 for intra prediction, the motion-compensated prediction frame memory 13, and the reference vector memory 14 can be configured on a memory of the computer, and a program in which the processes performed by the frame/field switch 2, the block partitioning unit 3, the select switch 4, the intra prediction unit 5, the motion-compensated prediction unit 6, the subtracting unit 7, the transformation/quantization unit 8, the inverse quantization/inverse transformation unit 9, the adding unit 10, the loop filter unit 12, and the variable length encoding unit 15 are described can be stored in a memory of the computer and the CPU of the computer can be made to execute the program stored in the memory.

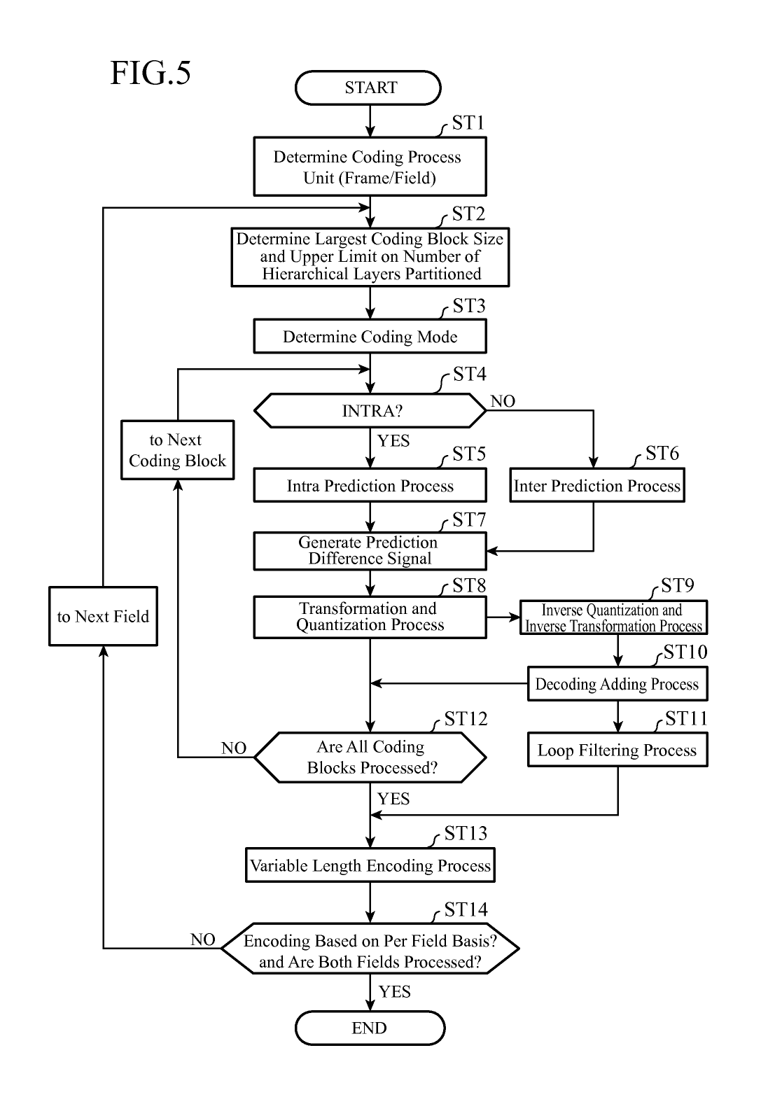

FIG. 5 is a flow chart showing the processing (video encoding method) performed by the video encoding device in accordance with Embodiment 1 of the present invention.

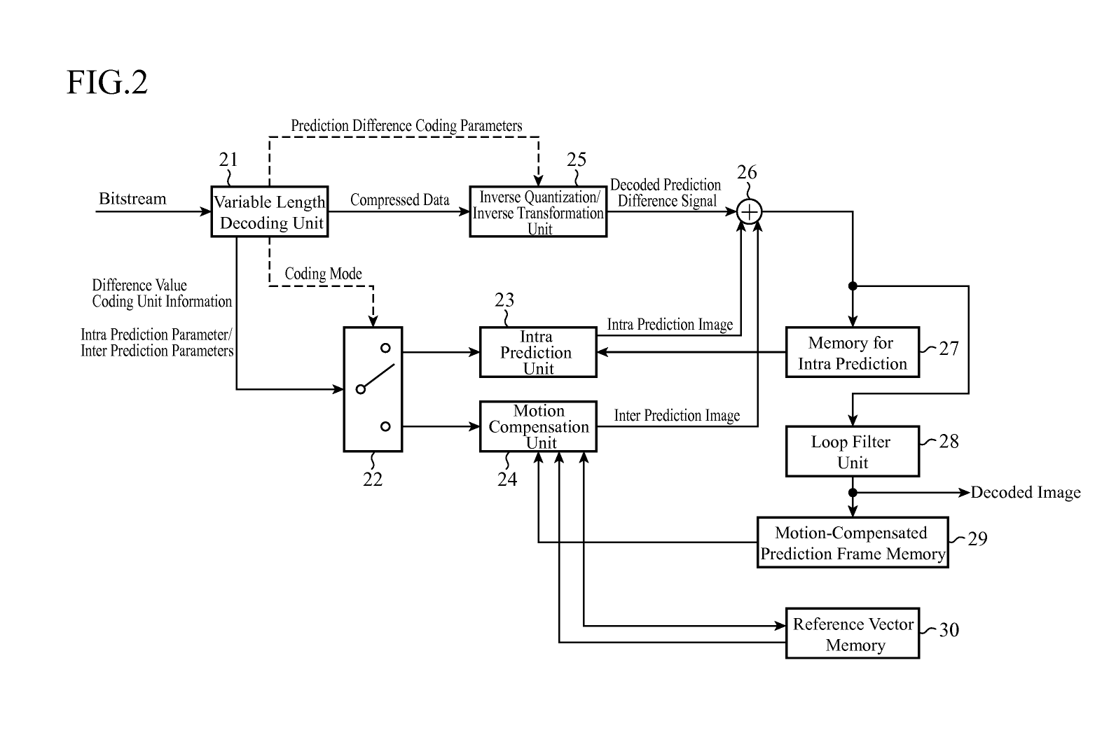

FIG. 2 is a block diagram showing the video decoding device in accordance with Embodiment 1 of the present invention.

Referring to FIG. 2, a variable length decoding unit 21 performs a process of variable-length-decoding the compressed data, the coding unit information, the coding mode, the intra prediction parameter (when the coding mode is an intra coding mode), the inter prediction parameters (when the coding mode is an inter coding mode), the prediction difference coding parameters, and the difference value between the motion vector and the prediction vector (when the coding mode is an inter coding mode) from the bitstream generated by the video encoding device shown in FIG. 1.

The variable length decoding unit 21 constructs a variable length decoder.

A select switch 22 performs a process of, when the coding mode variable-length-decoded by the variable length decoding unit 21 is an intra coding mode, outputting the intra prediction parameter variable-length-decoded by the variable length decoding unit 21 to an intra prediction unit 23, and, when the coding mode variable-length-decoded by the variable length decoding unit 21 is an inter coding mode, outputting the inter prediction parameters, the difference value, and the coding unit information which are variable-length-decoded by the variable length decoding unit 21 to a motion compensation unit 24.

The intra prediction unit 23 performs an intra prediction process on a decoding target block by using the intra prediction parameter outputted from the select switch 22 while referring to a decoded image stored in a memory 27 for intra prediction, and performs a process of generating an intra prediction image.

The motion compensation unit 24 derives a prediction vector from a reference vector stored in a reference vector memory 30 (reference vector held by a reference picture), adds the prediction vector and the difference value outputted from the select switch 22 and decodes the motion vector, performs an inter prediction process (motion-compensated prediction process) on the decoding target block by using both the motion vector and the inter prediction parameters outputted from the select switch 22, and performs a process of generating an inter prediction image.

At this time, the motion compensation unit 24 refers to the coding unit information outputted from the select switch 22 and recognizes the decoding unit of the current picture (decoding target picture), and, when the decoding unit of the current picture differs from that of the reference picture, corrects the reference vector held by the reference picture and derives the prediction vector from the corrected reference vector.

A prediction image generator is comprised of the select switch 22, the motion compensation unit 24, a motion-compensated prediction frame memory 29, and the reference vector memory 30.

An inverse quantization/inverse transformation unit 25 refers to the prediction difference coding parameters variable-length-decoded by the variable length decoding unit 21 and inverse-quantizes the compressed data variable-length-decoded by the variable length decoding unit 21, and also refers to the prediction difference coding parameters, performs an inverse orthogonal transformation process on the transform coefficients which are the compressed data inverse-quantized thereby, and performs a process of calculating a decoded prediction difference signal (difference image before compression) corresponding to the prediction difference signal outputted from the subtracting unit 7 shown in FIG. 1. The inverse quantization/inverse transformation unit 25 constructs a difference image generator.

An adding unit 26 performs a process of adding the decoded prediction difference signal calculated by the inverse quantization/inverse transformation unit 25 and either the intra prediction image generated by the intra prediction unit or the inter prediction image generated by the motion-compensated prediction unit 24, to calculate a decoded image (image of the decoding target bock) corresponding to the coding target block outputted from the block partitioning unit 3 shown in FIG. 1. The adding unit 26 constructs a decoded image generator.

The memory 27 for intra prediction is a recording medium that stores the decoded image calculated by the adding unit 26.

A loop filter unit 28 performs a predetermined filtering process on the decoded image calculated by the adding unit 26 and performs a process of outputting the decoded image filtering-processed thereby.

The motion-compensated prediction frame memory 29 is a recording medium that stores the decoded image filtering-processed.

The reference vector memory 30 is a recording medium that stores a reference vector which is used for the derivation of a time prediction vector at the time of decoding the next picture.

In the example of FIG. 2, it is assumed that the variable length decoding unit 21, the select switch 22, the intra prediction unit 23, the motion compensation unit 24, the inverse quantization/inverse transformation unit 25, the adding unit 26, the memory 27 for intra prediction, the loop filter unit 28, the motion-compensated prediction frame memory 29, and the reference vector memory 30, which are the components of the video decoding device, consist of pieces of hardware for exclusive use (e.g., semiconductor integrated circuits in each of which a CPU is mounted, one chip microcomputers, or the like), respectively. As an alternative, the video decoding device can consist of a computer.

In the case in which the video decoding device consists of a computer, the memory 27 for intra prediction, the motion-compensated prediction frame memory 29, and the reference vector memory 30 can be configured on a memory of the computer, and a program in which the processes performed by the variable length decoding unit 21, the select switch 22, the intra prediction unit 23, the motion compensation unit 24, the inverse quantization/inverse transformation unit 25, the adding unit 26, and the loop filter unit 28 are described can be stored in a memory of the computer and the CPU of the computer can be made to execute the program stored in the memory.

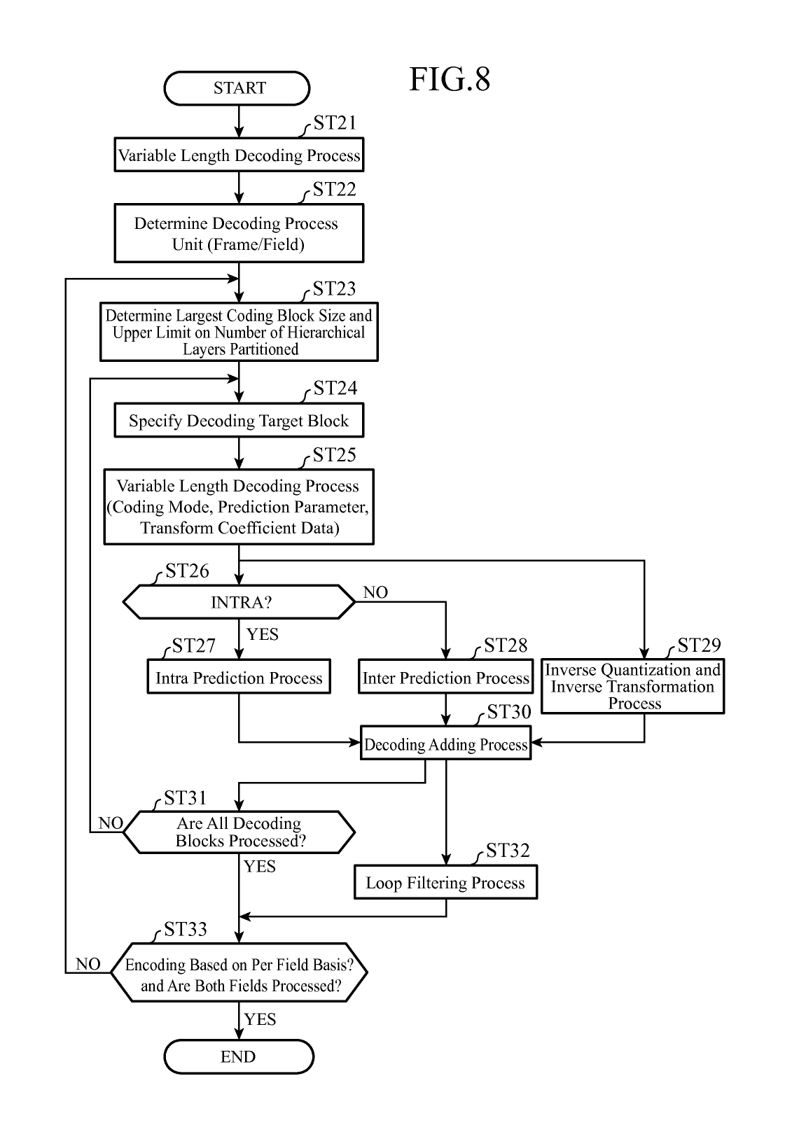

FIG. 8 is a flowchart showing processing (video decoding method) performed by the video decoding device in accordance with Embodiment 1 of the present invention.

Next, operations will be explained.

In this Embodiment 1, a case in which the video encoding device receives each frame image of a video as an inputted image, performs a motion-compensated prediction between adjacent frames, and performs a compression process with orthogonal transformation and quantization on an acquired prediction difference signal, and, after that, performs variable length encoding to generate a bitstream, and the video decoding device decodes the bitstream outputted from the video encoding device will be explained.

The video encoding device shown in FIG. 1 is characterized in that the video encoding device is adapted for local changes of a video signal in a space direction and in a time direction, partitions the video signal into blocks having various sizes, and performs intra-picture and inter-picture adaptive encoding.

In general, the video signal has a characteristic of its complexity locally changing in space and time. From the viewpoint of space, a certain video picture may have, for example, a pattern having a uniform signal characteristic in a relatively large image region, such as a sky image or a wall image, or a pattern in which a pattern having a complicated texture in a small image region, such as a person image or a picture including a fine texture, also coexists.

Also from the viewpoint of time, a sky image and a wall image have a small local change in a time direction in their patterns, while an image of a moving person or object has a larger temporal change because its outline has a movement of a rigid body and a movement of a non-rigid body with respect to time.

Although in the encoding process a process of generating a prediction difference difference signal having small signal power and small entropy by using a temporal and spatial prediction, thereby reducing the whole code amount, is performed, the code amount of a parameter used for the prediction can be reduced as long as the parameter can be applied uniformly to as large an image signal region as possible.

On the other hand, because the amount of errors occurring in the prediction increases when the same prediction parameter is applied to a large image region in an image signal pattern having a large change in time and space, the code amount of the prediction difference signal increases.

Therefore, it is desirable that, for an image region having a large change in time and space, the size of a block subjected to the prediction process to which the same prediction parameter is applied is reduced, thereby increasing the data volume of the parameter which is used for the prediction and reducing the electric power and entropy of the prediction difference signal.

In this Embodiment 1, a structure of, in order to perform encoding which is adapted for such the typical characteristics of a video signal, starting the prediction process and so on from a predetermined largest block size first, hierarchically partitioning the region of the video signal into blocks, and adapting the prediction process and the process of encoding the prediction difference to each of the blocks partitioned is provided.

The format of a video signal to be processed by the video encoding device shown in FIG. 1 is assumed to be an arbitrary video signal in which each video frame consists of a series of digital samples (pixels) in two dimensions, horizontal and vertical, including a color video signal in arbitrary color space, such as a YUV signal which consists of a luminance signal and two color difference signals or an RGB signal outputted from a digital image sensor, a monochrome image signal, an infrared image signal, and so on.

The gradation of each pixel can be an 8-bit, 10-bit, or 12-bit one.

In the following explanation, for the sake of convenience, the video signal of the inputted image is assumed to be, unless otherwise specified, a YUV signal, and a case of handling signals having a 4:2:0 format in which the two color difference components U and V are subsampled with respect to the luminance component Y will be described.

Further, data about a single image which is a unit to be encoded, such as a frame at the time of encoding the video signal on a per frame basis, or a field at the time of encoding the video signal on a per field basis, is referred to as a “picture.”

Further, in the following explanation, for the sake of convenience, the video signal of the inputted image is, unless otherwise specified, a video signal acquired by interlacing scanning, and a case in which each frame of the signal is a still image in which the top field and the bottom field are arranged alternately in the even and odd lines (or in the odd and even lines) respectively will be described. In addition, the format in which the top field and the bottom field are arranged in the even and odd lines respectively is referred to as the “frame format.”

The input data can be a video signal on which progressive scanning is performed. Further, when the input data is a video signal on which interlaced scanning is performed, the video signal can be the one in which the top field and the bottom field are alternately arranged in the even and odd lines (or in the odd and even lines) respectively in each frame, or the one in which the top field and the bottom field are alternately inputted as individual image data.

First, the details of the processing performed by the video encoding device shown in FIG. 1 will be explained.

First, for each frame (current frame) which constructs the inputted image, the encoding controlling unit 1 selects either each frame or each field as the coding unit of the frame, and outputs the coding unit information showing the coding unit to the frame/field switch 2, the motion-compensated prediction unit 6, and the variable length encoding unit 15.

As a method of selecting a coding unit, for example, the same coding unit can be determined uniformly for all the frames, or the coding efficiency of each of the coding units can be estimated by performing a preliminary encoding process or the like and a coding unit with a higher degree of coding efficiency can be selected.

Further, a certain characteristic of the inputted image, such as the amount of motion in the entire screen, can be quantified as a parameter, and a coding unit can be selected according to the parameter.

When receiving the coding unit information from the encoding controlling unit 1, the frame/field switch 2 generates a current picture (coding target picture) having a size of the coding unit shown by the coding unit information by rearranging the pixels of the current frame according to the coding unit information (step ST1 of FIG. 5).

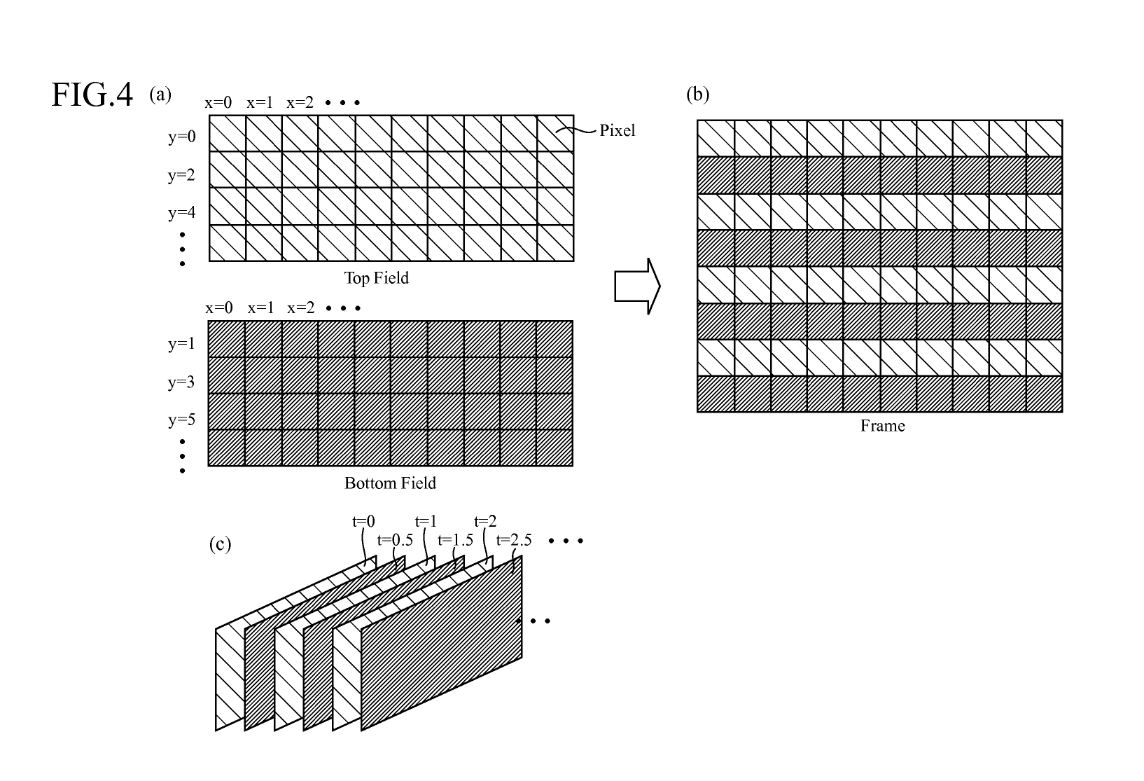

More specifically, when the coding unit shown by the coding unit information outputted from the encoding controlling unit 1 is “each frame”, the frame/field switch 2 generates, as the coding unit, a picture in which the top field and the bottom field are arranged in the even and odd lines respectively, as shown in FIG. 4 (b).

In contrast, when the coding unit shown by the coding unit information is “each field”, the frame/field switch generates, as different pictures, the top field and the bottom field, as shown in FIG. 4 (c).

As a result, when the coding unit is “each frame”, the current picture is encoded as a single picture. When the coding unit is “each field”, the current picture is encoded sequentially as two pictures.

Because the video decoding device has to perform a decoding process according to the completely same coding unit, the coding unit information is outputted to the variable length encoding unit 15 and is multiplexed into the bitstream.

Processes of steps ST2 to ST14 which will be explained hereafter are performed on a per picture basis.

The encoding controlling unit 1 determines the size of each largest coding block which is used for the encoding of the current picture, and an upper limit on the number of hierarchical layers with which each largest coding block is hierarchically partitioned (step ST2).

As a method of determining the size of each largest coding block, for example, there can be a method of determining the same size for all the pictures according to the resolution of the video signal of the inputted image, and a method of quantifying a variation in the complexity of a local movement of the video signal of the inputted image as a parameter and then determining a small size for a picture having a large and vigorous movement while determining a large size for a picture having a small movement.

As a method of determining the upper limit on the number of hierarchical layers partitioned, for example, there can be a method of increasing the number of hierarchical layers to make it possible to detect a finer movement as the video signal of the inputted image has a larger and more vigorous movement, or decreasing the number of hierarchical layers as the video signal of the inputted image has a smaller movement.

After the frame/field switch 2 generates the current picture, the block partitioning unit 3 partitions the current picture by using the largest coding block size determined by the encoding controlling unit 1, and hierarchically partitions the current picture after the partitioning until the number of hierarchical layers partitioned reaches the upper limit determined by the encoding controlling unit 1, and outputs each picture after the partitioning to the select switch 4 and the subtracting unit 7 as the coding target block.

The encoding controlling unit 1 also determines a coding mode for each coding target block (step ST3).

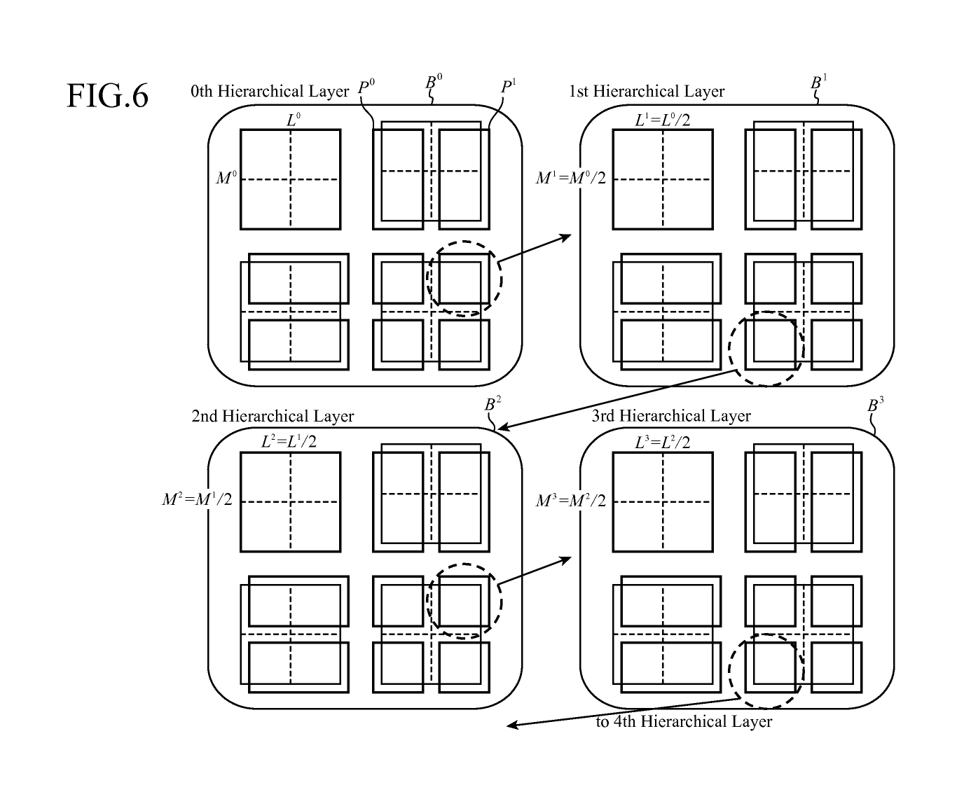

FIG. 6 is an explanatory drawing showing an example in which each largest coding block is hierarchically partitioned into a plurality of coding target blocks.

Referring to FIG. 6, each largest coding block is a coding target block whose luminance component, which is shown by “0th hierarchical layer”, has a size of (L⁰, M⁰).

By performing the hierarchical partitioning with this largest coding block being set as a starting point until the depth of the hierarchy reaches a predetermined depth which is set separately according to a quadtree structure, the coding target blocks can be acquired.

At the depth of n, each coding target block is an image region having a size of (Lⁿ, Mⁿ).

Although Lⁿ can be the same as or differ from Mⁿ, the case of Lⁿ=Mⁿ is shown in FIG. 6.

Hereafter, the coding block size determined by the encoding controlling unit 1 is defined as the size of (Lⁿ, Mⁿ) in the luminance component of each coding target block.

Because quadtree partitioning is performed, (Lⁿ⁺¹, Mⁿ⁺¹)=(Lⁿ/2, Mⁿ/2) is always established.

In the case of a color video signal (4:4:4 format) in which all the color components have the same sample number, such as an RGB signal, all the color components have a size of (Lⁿ, Mⁿ), while in the case of handling a 4:2:0 format, a corresponding color difference component has a coding block size of (Lⁿ/2, Mⁿ/2).

Hereafter, each coding target block in the nth hierarchical layer is expressed as Bⁿ, and a coding mode selectable for each coding target block Bⁿ is expressed as m(Bⁿ).

In the case of a color video signal which consists of a plurality of color components, the coding mode m(Bⁿ) can be configured in such a way that an individual mode is used for each color component, or can be configured in such a way that a common mode is used for all the color components. Hereafter, an explanation will be made by assuming that the coding mode indicates, unless otherwise specified, a coding mode for the luminance component of each coding block when having a 4:2:0 format in a YUV signal.

The coding mode m(Bⁿ) can be one of one or more intra coding modes (generically referred to as “INTRA”) or one or more inter coding modes (generically referred to as “INTER”), and the encoding controlling unit 1 selects a coding mode with the highest coding efficiency for each coding target block Bⁿ from among all the coding modes available in the picture currently being processed or a subset of these coding modes.

Each coding target block Bⁿ is further partitioned into one or more units for prediction process (partitions) by the block partitioning unit 3, as shown in FIG. 6.

Hereafter, each partition belonging to a coding target block Bⁿ is expressed as Pin (i shows a partition number in the nth hierarchical layer).

How the partitioning of each coding target block Bⁿ into partitions is performed is included as information in the coding mode m(Bⁿ).

While a prediction process is performed on each of all the partitions Pin according to the coding mode m(Bⁿ), an individual prediction parameter can be selected for each partition Pin.

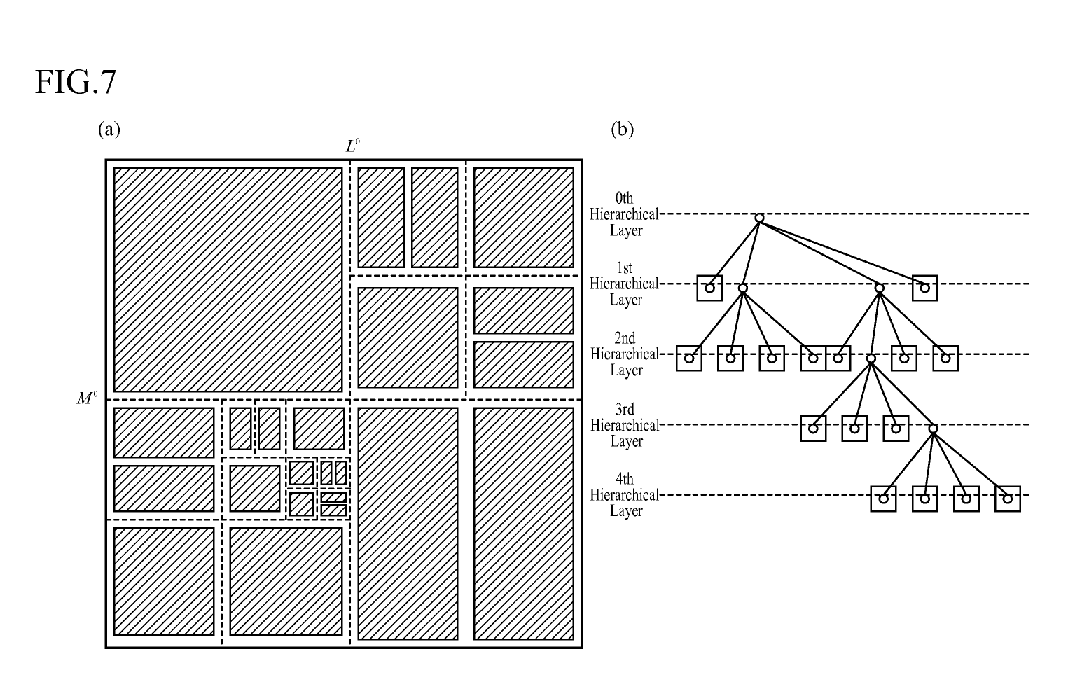

The encoding controlling unit 1 generates such a block partitioning state as shown in, for example, FIG. 7 for each largest coding block, and then determines coding target blocks.

Hatched portions shown in FIG. 7 (a) show a distribution of partitions after the partitioning, and FIG. 7 (b) shows a situation in which coding modes m(Bⁿ) are respectively assigned to the partitions according to the hierarchical layer partitioning by using a quadtree graph.

Each node enclosed by □ shown in FIG. 7 (b) is a node (coding target block) to which a coding mode m(Bⁿ) is assigned.

When the coding mode m(Bⁿ) determined by the encoding controlling unit 1 is an intra coding mode (when m(Bⁿ)εINTRA), the select switch 4 outputs the coding target block Bⁿ outputted from the block partitioning unit 3 to the intra prediction unit 5 (step ST4).

In contrast, when the coding mode m(Bⁿ) determined by the encoding controlling unit 1 is an inter coding mode (when m(Bⁿ) εINTER), the select switch outputs the coding target block Bⁿ outputted from the block partitioning unit 3 to the motion-compensated prediction unit 6 (step ST4).

When the coding mode m(Bⁿ) determined by the encoding controlling unit 1 is an intra coding mode (when m(Bⁿ)εINTRA), and the intra prediction unit 5 receives the coding target block Bⁿ from the select switch 4, the intra prediction unit performs an intra prediction process on each partition Pin in the coding target block Bⁿ by using the intra prediction parameter determined by the encoding controlling unit 1 while referring to the local decoded image stored in the memory 11 for intra prediction, to generate an intra prediction image P_{INTRAi}ⁿ (step ST5).

Because the video decoding device needs to generate an intra prediction image which is completely the same as the intra prediction image P_{INTRAi}ⁿ, the intra prediction parameter used for the generation of the intra prediction image P_{INTRAi}ⁿ is outputted from the encoding controlling unit 1 to the variable length encoding unit 15 and is multiplexed into the bitstream.

When the coding mode m(Bⁿ) determined by the encoding controlling unit 1 is an inter coding mode (when m(Bⁿ) EE INTER), and the motion-compensated prediction unit 6 receives the coding target block Bⁿ from the select switch 4), the motion-compensated prediction unit compares each partition Pin in the coding target block Bⁿ with the local decoded image which is stored in the motion-compensated prediction frame memory 13 and on which a filtering process is performed, to search for a motion vector, and performs an inter prediction process on each partition Pin in the coding target block Bⁿ by using both the motion vector and the inter prediction parameters determined by the encoding controlling unit 1, to generate an inter prediction image P_{INTERi}ⁿ (step ST6).

When searching for a motion vector, the motion-compensated prediction unit 6 derives a prediction vector from a reference vector stored in the reference vector memory 14 (reference vector held by a reference picture), and searches for a motion vector by using the prediction vector, as will later be described in detail.

At this time, when the coding unit of the current picture generated by the frame/field switch 2 differs from that of the reference picture, the motion-compensated prediction unit corrects the reference vector held by the reference picture and derives the prediction vector from the corrected reference vector, as will later be described in detail.

Because the video decoding device needs to generate an to inter prediction image which is completely the same as the inter prediction image P_{INTERi}ⁿ, the inter prediction parameters used for the generation of the inter prediction image P_{INTERi}ⁿ are outputted from the encoding controlling unit 1 to the variable length encoding unit 15 and are multiplexed into the bitstream.

The difference value between the motion vector which is searched for by the motion-compensated prediction unit 6 and the prediction vector is also outputted to the variable length encoding unit 15 and is multiplexed into the bitstream.

The details of the processing performed by the motion-compensated prediction unit 6 will be mentioned later.

When receiving the coding target block Bⁿ from the block partitioning unit 3, the subtracting unit 7 subtracts either the intra prediction image P_{INTRAi}ⁿ generated by the intra prediction unit 5 or the inter prediction image P_{INTERi}ⁿ generated by the motion-compensated prediction unit 6 from each partition Pin in the coding target block Bⁿ, and outputs a prediction difference signal eᵢⁿ which is the result of the subtraction to the transformation/quantization unit 8 (step ST7).

When receiving the prediction difference signal eᵢⁿ from the subtracting unit 7, the transformation/quantization unit refers to the prediction difference coding parameters determined by the encoding controlling unit 1 and performs an orthogonal transformation process (e.g., an orthogonal transformation process such as a DCT (discrete cosine transform) or a KL transform in which bases are designed for a specific learning sequence in advance) on the prediction difference signal eᵢⁿ, to calculate transform coefficients.

The transformation/quantization unit 8 also refers to the prediction difference coding parameters and quantizes the transform coefficients, and outputs compressed data which are the transform coefficients quantized thereby to the inverse quantization/inverse transformation unit 9 and the variable length encoding unit 15 (step ST8).

When receiving the compressed data from the transformation/quantization unit 8, the inverse quantization/inverse transformation unit 9 refers to the prediction difference coding parameters determined by the encoding controlling unit 1 and inverse-quantizes the compressed data.

The inverse quantization/inverse transformation unit 9 also refers to the prediction difference coding parameters and performs an inverse orthogonal transformation process (e.g., an inverse DCT or an inverse KL transform) on the transform coefficients which are the compressed data inverse-quantized thereby, to calculate a local decoded prediction difference signal eᵢⁿ hat corresponding to the prediction difference signal eᵢⁿ outputted from the subtracting unit 7, and outputs the local decoded prediction difference signal to the adding unit 10 (step ST9).

When receiving the local decoded prediction difference signal eᵢⁿ hat from the inverse quantization/inverse transformation unit 9, the adding unit 10 adds the local decoded prediction difference signal eᵢⁿ hat and either the intra prediction image P_{INTRAi}ⁿ generated by the intra prediction unit or the inter prediction image P_{INTERi}ⁿ generated by the to motion-compensated prediction unit 6 to calculate a local decoded image corresponding to the coding target block Bⁿ outputted from the block partitioning unit 3 as a local decoded partition image or a group of local decoded partition images (step ST10).

The adding unit 10 outputs the local decoded image to the loop filter unit 12 while storing the local decoded image in the memory 11 for intra prediction.

This local decoded image is an image signal for subsequent intra prediction.

When receiving the local decoded image from the adding unit 10, the loop filter unit 12 performs the predetermined filtering process on the local decoded image, and stores the local decoded image filtering-processed thereby in the motion-compensated prediction frame memory 13 (step ST11).

The picture data stored in the motion-compensated prediction frame memory 13 has a data format which makes it possible to make not only reference in the frame format but also reference in a field-specific format.

For example, the picture data can be stored in the frame format in which the top field and the bottom field are arranged alternately in the even and odd lines, or can be stored in a data format in which the top field and the bottom field are different picture data, while information showing which picture data corresponds to which of fields of which frame can be referred to at all times.

Further, both of them can be held.

Any of these storage formats has a structure of making it possible to make reference in any of the frame format and the field-specific format, including a means for performing format conversion as appropriate at the time of making reference.

By the way, the filtering process by the loop filter unit 12 can be performed on each largest coding block of the local decoded image inputted thereto or each coding block of the local decoded image. As an alternative, after the local decoded images of the coding blocks of one picture are inputted, the loop filter unit can perform the filtering process on the one picture at a time.

Further, as an example of the predetermined filtering process, there can be provided a process of filtering a block boundary in such a way as to make discontinuity (block noise) at the coding block boundary unobtrusive, a filtering process of compensating for a distortion occurring in the local decoded image in such a way that the local decoded image becomes similar to the video signal of the original inputted image, and so on.

The video encoding device repeatedly performs the processes of steps ST4 to ST11 until the video encoding device completes the processes on all the coding target blocks Bⁿ into which the inputted image is partitioned hierarchically, and, when completing the processes on all the coding target blocks Bⁿ, shifts to a process of step ST13 (step ST12).

The variable length encoding unit 15 variable-length-encodes the compressed data outputted from the transformation/quantization unit 8, the output signal of the encoding controlling unit 1 (the coding unit information, the coding mode m(Bⁿ), the prediction difference coding parameters, the intra prediction parameter (when the coding mode is an intra coding mode), and the inter prediction parameters (when the coding mode is an inter coding mode), and the difference value between the motion vector and the prediction vector which are outputted from the motion-compensated prediction unit 6 (when the coding mode is an inter coding mode), and generates a bitstream showing the encoded results of those data (step ST13).

The processes of steps ST2 to ST13 are repeatedly performed until the processes on all pictures which construct the current frame (one picture when the unit to be processed of the current frame is each frame, or two pictures when the unit to be processed of the current frame is each field) are completed, and, when the processes on all the pictures which construct the current frame are completed, the processes on the single frame of the inputted image are ended.

Hereafter, the details of the processing performed by the motion-compensated prediction unit 6 will be explained concretely.

When an inter coding mode is selected by the encoding controlling unit 1 as the coding mode (when m(Bⁿ)εINTER), the motion-compensated prediction unit 6 performs an inter-frame motion estimation process on each partition Pin on the basis of the inter prediction parameters outputted from the encoding controlling unit 1, to estimate a motion vector for each partition Pin.

After estimating a motion vector, the motion-compensated prediction unit 6 generates an inter prediction image by using both the motion vector and a reference frame in the motion-compensated prediction frame memory 13.

There can be a plurality of candidates for the reference frame, and, when there is one or more reference frames, the reference frame is specified according to reference frame index information included in the inter prediction parameters.

When the current picture is encoded on a per frame basis, the reference frame is referred to as the one in the frame format. In contrast, when the current picture is encoded on a per field basis, the reference frame is referred to as the one in the field-specific format.

When the current picture is encoded on a per field basis, and the reference frame is referred to as the one in the field-specific format, which of the top field and the bottom field in the reference frame is referred to is selected according to field index information included in the inter prediction parameters.

While the inter prediction image generated by the motion-compensated prediction unit 6 is outputted to the subtracting unit 7, the inter prediction parameters used for the generation of the inter prediction image is outputted to the variable length encoding unit 15 and is multiplexed into the bitstream by the variable length encoding unit 15 in order for the video decoding device to generate the completely same inter prediction image.

In order to use the motion vector of each partition Pin acquired through the inter-frame motion estimation process for a motion vector prediction process (which will be mentioned later) on a subsequent picture, the motion vector is stored, in a data structure which is called a reference vector map, in the reference vector memory 14. Specifications of the reference vector map will be mentioned later.

In accordance with this Embodiment 1, the motion-compensated prediction unit 6 performs a motion vector prediction process, which will be mentioned later, by using the fact that there is a correlation of motion vector information between adjacent frames.

By using a prediction vector derived by the motion vector prediction process as a search start point at the time of searching for a motion vector, the prediction vector can be used for a reduction in the process of searching for a motion vector, and for an improvement in the accuracy of the process.

By calculating the difference value (prediction difference motion vector information) between the motion vector acquired as a result of the search, and the prediction vector, and then encoding this difference value as an inter prediction parameter, the amount of information of the motion vector information can be reduced.

Hereafter, the details of the motion vector prediction process will be explained.

As the prediction vector, two types of prediction vectors exist, including a space prediction vector and a time prediction vector. The space prediction vector uses a motion vector at a predetermined position close to the space of the partition which is the target for prediction. There can be a plurality of candidates for the space prediction vector.

The time prediction vector is stored in the reference vector memory 14, and uses a reference vector which is included in the reference vectors in the reference vector map structurally expressing the motion vector in each screen area of each reference picture, and which corresponds to the position of the partition to be processed of the current picture.

The reference frame which is a source image for the generation of pixel values in the motion-compensated prediction, and the reference vector map for the derivation of the time prediction vector can be different frames, and the reference frame for the derivation of the time prediction vector is selected by using a reference vector map index included in the inter prediction parameters.

Hereafter, the reference frame for reference to a pixel is referred to as the “pixel reference frame”, and the reference frame for reference to a reference vector is referred to as the “vector reference frame.”

Also for the time prediction vector, there can be a plurality of candidates derived according to a predetermined time prediction vector derivation algorithm.

From a plurality of candidates which are a combination of space prediction vector candidates and time prediction vector candidates, one prediction vector is selected according to a prediction vector index included in the inter prediction parameters, and the prediction vector is determined as the prediction vector for the coding target partition.

Next, an explanation will be made as to the time prediction vector deriving process in a case in which the encoding based on a per field basis and the encoding based on a per frame basis coexist, including the data structure of the reference vector map.

First, the data structure of the reference vector map will be explained.

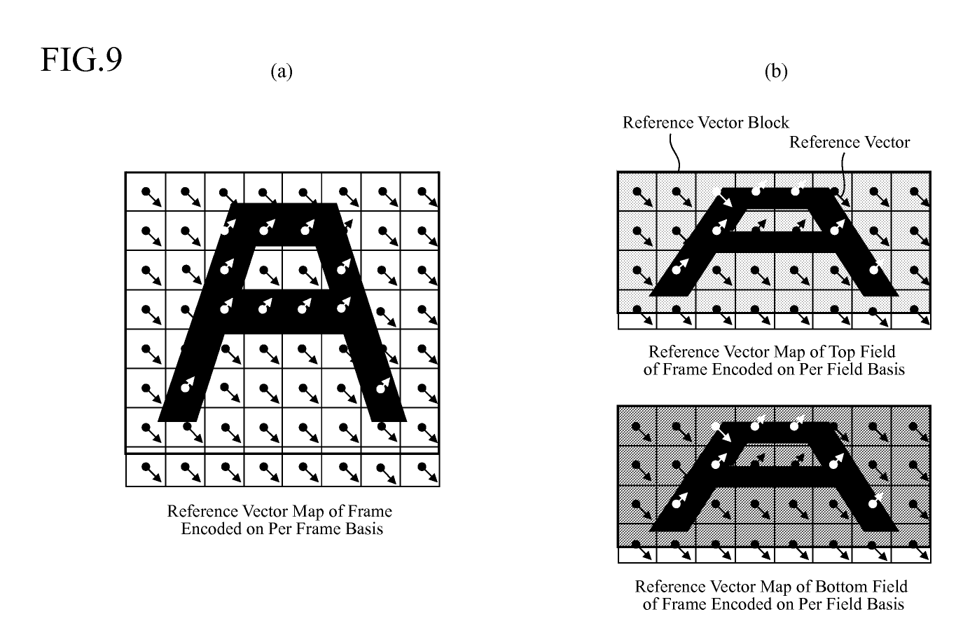

The reference vector map is configured to have a structure in which the coding target picture is partitioned into blocks, in a grid form, each having a specific size which are referred to as reference vector blocks, and motion vectors respectively corresponding to the reference vector blocks are stored in the raster order (refer to FIG. 9).

In this case, although a single motion vector is defined for each partition Pin for which a motion-compensated prediction is selected, there is a possibility that a partition Pin spatially corresponding to a certain reference vector block differs in size and in shape from the reference vector block.

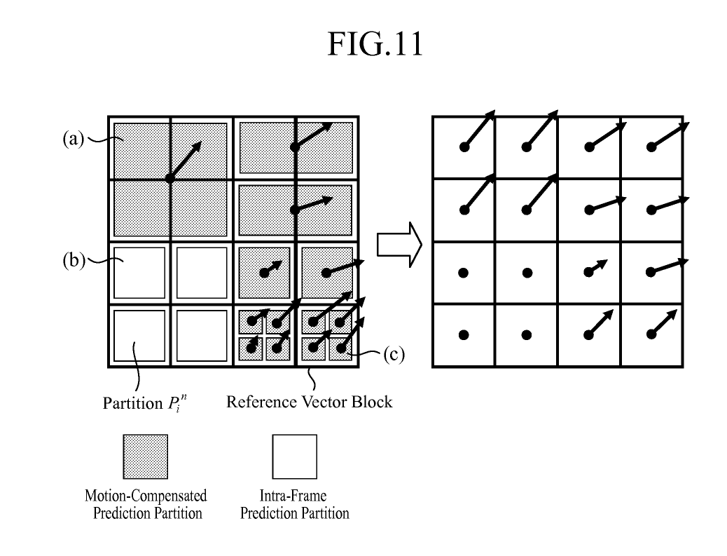

In such a case, a correspondence between the reference vector block and the partition Pin is established by using a specific means. For example, when a partition Pin on which a motion-compensated prediction is performed extends over a plurality of reference vector blocks, as shown in FIG. 11 (a), the vector of the partition Pin is stored for all the reference vector blocks including the partition Pin. When a plurality of partitions are included in one reference vector block, as shown in FIG. 11(c), one vector is calculated from the vectors of the plurality of partitions included in the reference vector block by using a specific means, and is stored in the reference vector block.

As a method of calculating the vector, there can be provided, for example, a method of calculating the mean value or the median value of all the vectors included in the reference vector block. As an alternative, the motion vector of a partition at a specific position in the reference vector block can be used as a representative value at all times.

In a reference vector block corresponding to the position of an intra-frame prediction partition, as shown in FIG. 11 (b), a vector calculated by using a specific means is stored.

As a method of calculating the vector, there can be provided a method of storing a fixed value, a method of copying the vector value of an adjacent reference vector block and storing this value, and so on.

Coordinates on a reference vector map which correspond to coordinates (x, y) on a picture are expressed by (R₁(x), R₂(x)).

When the vector reference frame is encoded on a per frame basis, a single reference vector map is provided for the frame, as shown in FIG. 9(a), whereas when the vector reference frame is encoded on a per field basis, a single reference vector map separately for each field, i.e., two reference vector maps in total are provided, as shown in FIG. 9(b).

More specifically, when the current picture is encoded on a per frame basis, a single reference vector map is generated, whereas when the current picture is encoded on a per field basis, a single reference vector map separately for each field, i.e., two reference vector maps are generated.

The size of each reference vector block at the time of generating a reference vector map is assumed to be constant independently of whether either the encoding based on a per frame basis or the encoding based on a per field basis is performed.

Therefore, the size of a single reference vector map differs between the encoding based on a per frame basis and the encoding based on a per field basis.

Next, the process of deriving the time prediction vector in the case in which the encoding based on a per field basis and the encoding based on a per frame basis coexist will be explained.

Hereafter, an explanation will be made as to the following four patterns: (1) pattern in which the current picture is encoded on a per frame basis and the vector reference frame is encoded on a per frame basis, (2) pattern in which the current picture is encoded on a per field basis and the vector reference frame is encoded on a per field basis, (3) pattern in which the current picture is encoded on a per frame basis and the vector reference frame is encoded on a per field basis, and (4) pattern in which the current picture is encoded on a per field basis and the vector reference frame is encoded on a per frame basis.

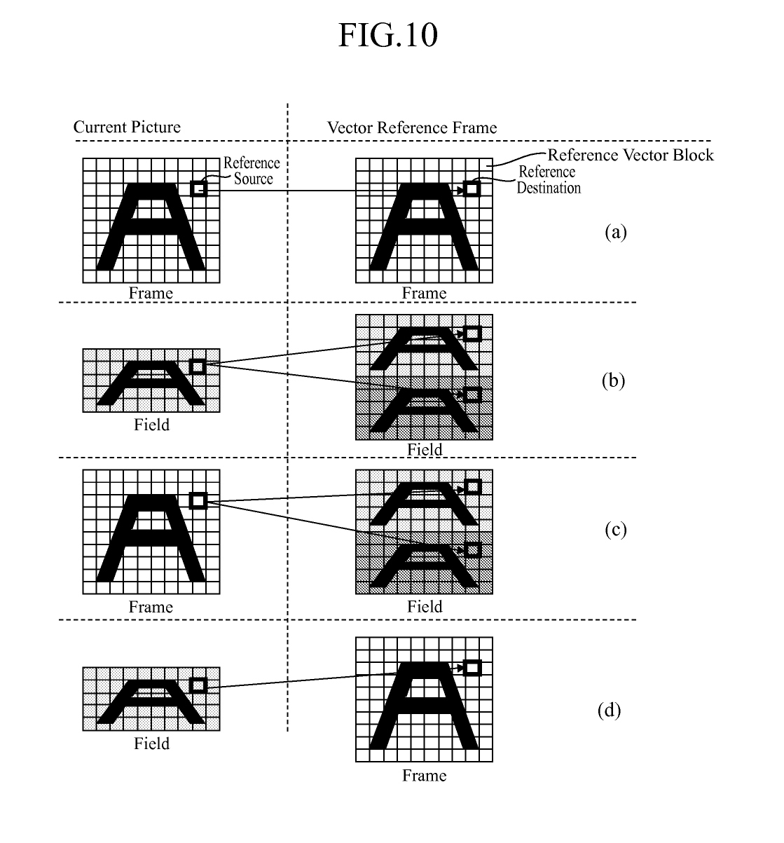

FIG. 10 is an explanatory drawing regarding the process of deriving the time prediction vector in the case in which the encoding based on a per field basis and the encoding based on a per frame basis coexist.

### [Pattern (1)]

The pattern in which the current picture is encoded on a per frame basis and the vector reference frame is encoded on a per frame basis (refer to FIG. 10(a))

In this pattern, when C candidates regarding the coordinates of the reference destination of the time prediction vector in the coding target partition in the current picture are determined, as (x₁, y₁), (x₂, y₂), . . . , (x_{c}, y_{c}) each showing coordinates on the current picture, according to the predetermined time prediction vector derivation algorithm, the reference vectors respectively stored in (R₁(x₁), R₂(y₁)), (R₁ (x₂), R₂ (y₂)), . . . , (R₁ (x_{c}), R₂ (y_{c})) of the reference vector map of the vector reference frame in the current picture are determined as candidates for the time prediction vector.

### [Pattern (2)]

The pattern in which the current picture is encoded on a per field basis and the vector reference frame is encoded on a per field basis (refer to FIG. 10(b))

In this pattern, when C candidates regarding the coordinates of the reference destination of the time prediction vector in the coding target partition in the current picture are determined, as (x₁, y₁), (x₂, y₂), . . . , (x_{c}, y_{c}) each showing coordinates on the current picture, according to the predetermined time prediction vector derivation algorithm, the reference vectors respectively stored in (R₁(x₁), R₂(y₁)), (R₁ (x₂), R₂ (y₂)), . . . , (R₁ (x_{c}), R₂ (y_{c})) of the reference vector map, which is included in the two reference vector maps of the vector reference frame in the current picture, of the same field as the current picture (when the current picture is the top field, the reference vector map of the top field, whereas when the current picture is the bottom field, the reference vector map of the bottom field) are determined as candidates for the time prediction vector.

As an alternative, the reference vectors respectively stored in (R₂(x₂), R₂(y₂)), (R₂(x₂), R₂(y₂)), . . . , (R₂(x_{c}), R₂(y_{c})) of the reference vector map, which is included in the two reference vector maps of the vector reference frame in the current picture, of the field shown by a time prediction vector reference field index included in the inter prediction parameters outputted from the encoding controlling unit 1 are determined as candidates for the time prediction vector. Switching between always using the same field according to an instruction based on a coding parameter outputted from the encoding controlling unit 1 and specifying the field shown by the time prediction vector reference field index can be performed on a per sequence basis, a per picture basis, a per slice basis, or any other basis.

### [Pattern (3)]

The pattern in which the current picture is encoded on a per frame basis and the vector reference frame is encoded on a per field basis (refer to FIG. 10(c))

In this pattern, when C candidates regarding the coordinates of the reference destination of the time prediction vector in the coding target partition in the current picture are determined, as (x₁, y₁), (x₂, y₂), . . . , (x_{c}, y_{c}) each showing coordinates on the current picture, according to the predetermined time prediction vector derivation algorithm, vectors (corrected reference vectors) in which the vertical components of the reference vectors respectively stored in (R₁ (x₁), R₂ (y₁)/2), (R₁ (x₂), R₂ (y₂)/2), . . . , (R₁ (x_{c}), R₂ (y_{c})/2) of the reference vector map, which is included in the two reference vector maps of the vector reference frame in the current picture, of the field shown by the time prediction vector reference field index included in the inter prediction parameters outputted from the encoding controlling unit 1 are increased by two times are determined as candidates for the time prediction vector.

### [Pattern (4)]

The pattern in which the current picture is encoded on a per field basis and the vector reference frame is encoded on a per frame basis (refer to FIG. 10(d))

In this pattern, when C candidates regarding the coordinates of the reference destination of the time prediction vector in the coding target partition in the current picture are determined, as (x₁, y₁), (x₂, y₂), . . . , (x_{c}, y_{c}) each showing coordinates on the current picture, according to the predetermined time prediction vector derivation algorithm, vectors (corrected reference vectors) in which the vertical components of the reference vectors respectively stored in (R₁ (x₁), R₂ (y₁)×2), (R₁ (x2), R₂ (y₂)×2), . . . , (R₁ (x_{c}), R₂ (y_{c})×2) of the reference vector map, which is included in the two reference vector maps of the vector reference frame in the current picture, of the field shown by the time prediction vector reference field index included in the inter prediction parameters outputted from the encoding controlling unit 1 are decreased to half are determined as candidates for the time prediction vector.

In any of the patterns (1) to (4), the motion-compensated prediction unit 6 determines, as final time prediction vector candidates, vectors which the motion-compensated prediction unit acquires by scaling the determined C time prediction vector candidates with the difference in picture number between the current picture and the vector reference frame.

Although pieces of information shown below and so on are included in the inter prediction parameters used for the generation of the inter prediction image, these pieces of information and so on are multiplexed into the bitstream by the variable length encoding unit 15 in order for the video decoding device to generate the completely same inter prediction image.

(1) Mode information describing the partitioning into partitions in the coding block Bⁿ.

(2) The prediction difference motion vector (difference value) of each partition.

(3) Pixel reference frame specification index information specifying the pixel reference frame for the generation of the prediction image in a configuration in which a plurality of reference frames are included in the motion-compensated prediction frame memory 13.

(4) Vector reference frame specification index information specifying the vector reference frame which is the reference destination of the time prediction vector in a configuration in which a plurality of reference vector maps are included in the reference vector memory 14.

(5) Pixel reference field specification index information showing which of the fields of the pixel reference frame is used as the reference picture in a configuration in which switching between frame and field is performed on a per frame basis and the encoding is performed, and in the case in which the current picture is encoded on a per field basis.

(6) Vector reference field specification index information showing which of the reference vector maps of the fields of the vector reference frame is used in a configuration in which switching between frame and field is performed on a per frame basis and the encoding is performed, and when the vector reference frame is encoded on a per field basis.

(7) Index information showing which motion vector predicted value is selected and used in a case in which there are a plurality of motion vector predicted value candidates.

(8) Index information showing which filter is selected and used in a case in which there are a plurality of motion compensation interpolation filters.

(9) Selection information showing which pixel accuracy is used in a case in which the motion vector of the partition can exhibit a plurality of degrees of pixel accuracy (half pixel, ¼ pixel, ⅛ pixel, and so on).

Further, each of the pieces of information (5) and (6), among the above-mentioned pieces of information, is a 1-bit signal specifying a field parity (the top field or the bottom field). As a means of configuring these signals, the following two patterns can be provided.

### [Pattern 1]

The correspondence between the field parity to be specified and the signal value is fixed. More specifically, for example, when specifying the top field, “0” is transmitted fixedly, whereas when specifying the bottom field, “1” is transmitted fixedly.

### [Pattern 2]

The correspondence between the field parity to be specified and the signal value is changed according to the field parity to be encoded. For example, when the field parity to be encoded and the field parity to be specified are equal, “0” is transmitted, whereas when they differ, “0” is transmitted. By configuring in this way, for example, in a case in which the inputted image is an image, such as a still image, having a characteristic of the coding efficiency increasing when the field parity of the coding target field matches that of the reference field, the field specification index information can be compressed with a high degree of efficiency by using arithmetic encoding because “0” appears frequently as the signal value of the field specification index information.

Next, the processing performed by the video decoding device shown in FIG. 2 will be explained concretely.

When receiving the bitstream generated by the video encoding device shown in FIG. 1, the variable length decoding unit 21 performs a variable length decoding process on the bitstream(step ST21 of FIG. 8) and decodes the frame size information on a per sequence basis, each sequence consisting of one or more frames of pictures, or on a per picture basis.

More specifically, the variable length decoding unit 21 decodes the coding unit information (information showing whether either the encoding based on a per frame basis or the encoding based on a per field basis is performed) which is multiplexed into the bitstream, and determines the coding unit (decoding unit) of the current picture for either decoding based on a per frame basis or decoding based on a per field basis on the basis of the coding unit information (step ST22).

The variable length decoding unit 21 also determines a largest coding block size and an upper limit on the number of hierarchical layers partitioned according to the same procedure as that of the video encoding device shown in FIG. 1 (step ST23).

For example, when the largest coding block size is determined according to the resolution of the video signal, the variable length decoding unit determines the largest coding block size on the basis of the decoded frame size information and according to the same procedure as that of the video encoding device.

When the largest coding block size and the upper limit on the number of hierarchical layers partitioned are multiplexed into the bitstream by the video encoding device, the variable length decoding unit uses the values decoded from the bitstream.

The video encoding device multiplexes the coding mode and the compressed data which are acquired through transformation and quantization into the bitstream on a per coding target block basis, each coding target block being acquired by performing hierarchical partitioning into a plurality of coding target blocks with each largest coding block being set as a starting point, as shown in FIG. 6.

The variable length decoding unit 21 which has received the bitstream decodes, for each determined largest coding block, the partitioning state of the largest coding block as shown in FIG. 6, the partitioning state being included in the coding mode. The variable length decoding unit hierarchically specifies decoding target blocks (i.e., blocks corresponding to “coding target blocks” in the video encoding device shown in FIG. 1) on the basis of the decoded partitioning state (step ST24).

Next, the variable length decoding unit 21 decodes the coding mode assigned to each decoding target block corresponding to a coding target block. The variable length decoding unit further partitions each decoding target block corresponding to a coding target block into one or more units for prediction process on the basis of information included in the decoded coding mode, and decodes the prediction parameter assigned to each of the units for prediction process (step ST25).

When the coding mode assigned to the decoding target block (coding target block) is an intra coding mode, the variable length decoding unit 21 decodes the intra prediction parameter for each of the one or more partitions which are included in the decoding target block (coding target block) and each of which is a unit for prediction process.

In addition, the variable length decoding unit 21 partitions the decoding target block (coding target block) into one or more partitions each of which is a unit for transformation process on the basis of the transformation block size information included in the prediction difference coding parameters, and decodes the compressed data (the transform coefficients transformed and quantized) for each partition which is a unit for transformation process (step ST25).

When the coding mode m(Bⁿ) variable-length-decoded by the variable length decoding unit 21 is an intra coding mode (when m(Bⁿ)εINTRA), the select switch 22 outputs the intra prediction parameter variable-length-decoded by the variable length decoding unit 21 to the intra prediction unit 23.

In contrast, when the coding mode m(Bⁿ) variable-length-decoded by the variable length decoding unit 21 is an inter coding mode (when m(Bⁿ)εINTER), the select switch to outputs the inter prediction parameters, the difference value, and the coding unit information which are variable-length-decoded by the variable length decoding unit 21 to the motion compensation unit 24.

When the coding mode m(Bⁿ) variable-length-decoded by the variable length decoding unit 21 is an intra coding mode (when m(Bⁿ)εINTRA), and the intra prediction unit 23 receives the intra prediction parameter from the select switch 22 (step ST26), according to the same procedure as that of the intra prediction unit 54 shown in FIG. 1, the intra prediction unit performs an intra prediction process on each partition Pin in the decoding target block Bⁿ by using the intra prediction parameter outputted from the select switch 22 while referring to the local decoded image stored in the memory 27 for intra prediction, to generate an intra prediction image P_{INTRAi}ⁿ (step ST27).

When the coding mode m(Bⁿ) variable-length-decoded by the variable length decoding unit 61 is an inter coding mode (when m(Bⁿ)εINTER), and the motion compensation unit 24 receives the inter prediction parameters, the difference value, and the coding unit information from the select switch 22 (step ST26), the motion compensation unit derives a prediction vector from the reference vector stored in the reference vector memory 30 (reference vector held by the reference picture), adds the prediction vector and the difference value outputted from the select switch 22 and decodes the motion vector, and performs an inter prediction process on the decoding target block by using both the motion vector and the inter prediction parameters outputted from the select switch 22, to generate an inter prediction image P_{INTERi}ⁿ as will later be described in detail (step ST28).

The motion compensation unit 24 refers to the coding unit information outputted from the select switch 22 and recognizes the decoding unit of the current picture (decoding target picture), and, when the decoding unit of the current picture differs from that of the reference picture, corrects the reference vector held by the reference picture and derives the prediction vector from the corrected reference vector.

When receiving the compressed data and the prediction difference coding parameters from the variable length decoding unit 21, according to the same procedure as that of the inverse quantization/inverse transformation unit 9 shown in FIG. 1, the inverse quantization/inverse transformation unit 25 refers to the prediction difference coding parameters and inverse-quantizes the compressed data, and also refers to the prediction difference coding parameters and performs an inverse orthogonal transformation process on the transform coefficients which are the compressed data inverse-quantized thereby and calculates a decoded prediction difference signal corresponding to the prediction difference signal outputted from the subtracting unit 7 shown in FIG. 1 (step ST29).

The adding unit 26 adds the decoded prediction difference signal calculated by the inverse quantization/inverse transformation unit 25 and either the intra prediction image P_{INTRAi}ⁿ generated by the intra prediction unit 23 or the inter prediction image P_{INTERi}ⁿ generated by the motion compensation unit 24, and outputs, as a group of one or more decoded partition images included in the decoding target block, a decoded image to the loop filter unit 28 and also stores the decoded image in the memory 27 for intra prediction (step ST30).

This decoded image is an image signal for subsequent intra prediction.

After the processes of steps ST23 to ST30 on all the decoding target blocks Bⁿ are completed (step ST31), the loop filter unit 28 performs a predetermined filtering process on the decoded image outputted from the adding unit 26 and stores the decoded image filtering-processed thereby in the motion-compensated prediction frame memory 29 (step ST32).

The filtering process by the loop filter unit 28 can be performed on each largest decoding block of the decoded image inputted thereto or each decoding block of the decoded image. As an alternative, after the local decoded images of the decoding blocks of one screen are inputted, the filtering process can be performed on the one screen at a time.

Further, as an example of the predetermined filtering process, there can be provided a process of filtering a block boundary in such a way as to make discontinuity (block noise) at the coding block boundary unobtrusive, a filtering process of compensating for a distortion occurring in the decoded image, and so on.

This decoded image is a reference image for motion-compensated prediction, and is also a reproduced image.

The picture data stored in the motion-compensated prediction frame memory 29 has a data format which makes it possible to make not only reference in the frame format but also reference in the field-specific format.

For example, the picture data can be stored in the frame format in which the top field and the bottom field are arranged alternately in the even and odd lines, or can be stored in a data format in which the top field and the bottom field are different picture data, while information showing which picture data corresponds to which of fields of which frame can be referred to at all times. Further, both of them can be held.

Any of these storage formats has a structure of making it possible to make reference in any of the frame format and the field-specific format, including a means for performing format conversion as appropriate at the time of making reference.

The processes of steps ST23 to ST32 are performed repeatedly until the processes on all the pictures which construct the current frame (one picture when the unit to be processed of the current frame is each frame, or two pictures when the unit to be processed of the current frame is each field) are completed (step ST33), and, when the processes on all the pictures which construct the current frame are completed, the decoding process on the encoded data about the single frame included in the encoded data multiplexed into the bitstream is ended.

Hereafter, the details of the processing performed by the motion compensation unit 24 will be explained concretely.

In the encoding controlling unit 1 shown in FIG. 1, when an inter coding mode is selected (when m(Bⁿ), INTER), a motion vector prediction process is performed on each partition Pin to select prediction vector candidates and a prediction vector is determined from the prediction vector candidates on the basis of the prediction vector index information included in the inter prediction parameters decoded by the variable length decoding unit 21, and the motion vector of each partition Pin is also decoded by adding the difference value, which is included in the inter prediction parameters, and the prediction vector.

Further, an image in which motion compensation is performed on the pixel reference frame shown by the pixel reference frame index information included in the inter prediction parameters by using the motion vector is generated as an inter prediction image. An algorithm for deriving the prediction vector is the same as that of the process performed by the motion-compensated prediction unit 6 of the video encoding device shown in FIG. 1, and the same prediction vector candidates are selected certainly for the same partition in the same frame between the video encoding device and the video decoding device.

Further, the reference to a pixel from the pixel reference frame is changed as appropriate on the basis of the coding unit of the current picture, like in the case of the process performed by the motion-compensated prediction unit 6 of the video encoding device shown in FIG. 1.

In addition, also in the acquisition of a time prediction vector from the reference vector map of the vector reference frame, a process of changing the reference position from the reference vector map and the vector value of the reference vector according to the coding unit of the current picture and the coding unit of the vector reference frame, and so on are performed in the completely same way as the process performed by the motion-compensated prediction unit 6 of the video encoding device shown in FIG. 1.

Further, a reference vector map of the current picture is generated according to the coding unit of the current picture in the completely same way as the process performed by the motion-compensated prediction unit 6 of the video encoding device shown in FIG. 1, and is stored in the reference vector memory 30.

As can be seen from the above description, in accordance with this Embodiment 1, because the motion-compensated prediction unit 6 is configured in such a way as to, when the coding unit of the coding target picture differs from that of the reference picture, correct the reference vector held by the reference picture and derive a prediction vector from the corrected reference vector, there is provided an advantage of being able to achieve application to the HEVC even when the encoding based on a per frame basis and the encoding based on a per field basis coexist.

More specifically, because an appropriate time prediction vector can be derived even when the coding unit of the current picture differs from that of the reference picture, switching between the encoding based on a per frame basis and the encoding based on a per field basis can be performed on a per frame basis. As a result, there is provided an advantage of being able to compression-encode the inputted image with a high degree of efficiency.

### Embodiment 2

In above-mentioned Embodiment 1, it is configured that when the coding unit of the current picture is field encoding, one reference vector map is provided separately for each field, that is, two reference vector maps in total are provided.

However, because the top field and the bottom field have similar motion information in many image signals, it is expected that pieces of reference vector information stored in the two reference vector maps have similar values (redundant information). Further, because each field of an interlaced material is an image in which the size in a vertical direction of a captured video is reduced, a correlation between pixels and a motion information correlation in the vertical direction are small generally compared with those in a horizontal direction. It is therefore expected that also in the case of the reference vector maps, it is preferable to make it possible to store the vector information with a higher degree of granularity than that in the vertical direction, thereby improving the accuracy of the prediction vector.

For this reason, in accordance with this Embodiment 2, it is configured that the top field and the bottom field share a single reference vector map. At this time, by making the size of the reference vector map shared be equal to that of a picture on which frame encoding is performed, the degree of granularity in the vertical direction for storing reference vectors is improved.

A means for storing a reference vector in the reference vector map at the time of performing field encoding in the case of this configuration will be explained hereafter.

First, a reference vector map is generated separately for each of the top and bottom fields. At this time, unlike in the case of above-mentioned Embodiment 1, a reference vector map having a size of one frame at the time of frame encoding is generated for each of the top and bottom fields.

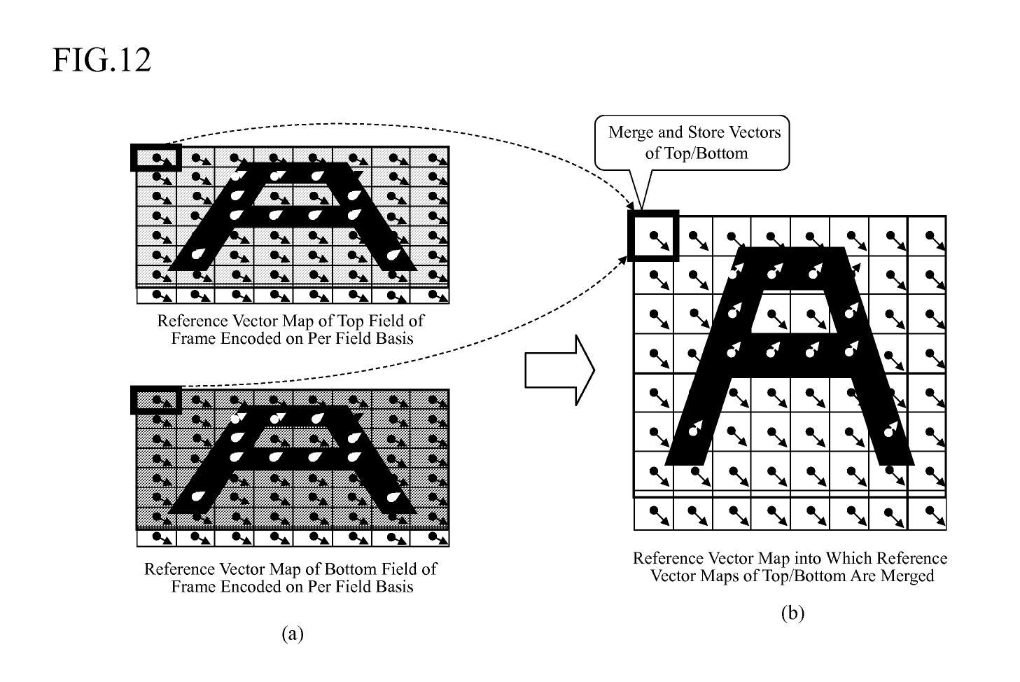

More specifically, as shown in FIG. 12(a), assuming that each reference vector block at the time of frame encoding corresponds to a V×V pixel block of the coding target picture, each reference vector block at the time of field encoding corresponds to a V×(V/2) block. For calculation of a reference vector which is stored in each reference vector block, the same method as that explained in above-mentioned Embodiment 1 is used.

When the encoding on both the top field and the bottom field is completed and two reference vector maps are generated, both the reference vector maps are merged to generate a single reference vector map, and this reference vector map is determined as the reference vector map of the frame.

A vector value stored in each reference vector block after the merge is calculated by a specific means by using the vector values stored in the reference vector blocks at the same position in the top field and the bottom field.

As a method of calculating the vector value, for example, a mean value can be used or a vector having a higher correlation than vector data stored in an adjacent reference vector block can be selected.

Further, in the case in which the reference vector map is configured as above, even when the coding unit is a frame and even when the coding unit is a field, only one reference vector map exists for each frame, and this reference vector map always has the same size. Therefore, a reference pattern as shown in FIG. 10 (b) or FIG. 10 (d) does not exist. Accordingly, the vector reference specification index which is one inter prediction parameter becomes unnecessary.

By configuring in the above-mentioned way, there is provided an advantage of standardizing the size of the reference vector map for all the frames and simplifying a method of referring to the prediction vector when the coding unit of the coding target picture differs from that of the reference picture, and also improving the degree of granularity in the vertical direction for storage of reference vectors.

### Embodiment 3

In above-mentioned Embodiment 1, when the coding target picture is encoded on a per field basis, the field which is the pixel reference destination is specified by transmitting, as inter prediction parameters, in addition to the pixel reference frame specification index information specifying the pixel reference frame for the generation of a prediction image, the pixel reference field specification index information specifying which of the top field and the bottom field of the pixel reference frame specified by the pixel reference frame specification index is used.

Hereafter, in a certain frame which is encoded on a per field basis, a field which is encoded first is expressed by F₁ and a field which is encoded second is expressed by F₂. At this time, in the encoding of the field F₂, the field F₁ can be referred to.

In the case of the structure of using the pixel reference frame specification index information and the pixel reference field specification index information for the specification of a reference field, like in the case of above-mentioned Embodiment 1, when referring to the field F₁ at the time of encoding the field F₂, it is necessary to first specify the current coding target frame (the frame to which the frames F₁ and F₂ belong) by using the pixel reference frame specification index information, and specify the field F₁ by using the pixel reference field specification index information. In this parameter transmitting means, for an input, such as an image having a large and vigorous movement, having a characteristic of the coding efficiency being improved by referring to the field F₁ at the time of encoding the field F₂, the code amount of the inter prediction parameters transmitted increases.

To solve this problem, in this Embodiment 3, a structure that makes it possible for the field F₂ to refer to the field F₁ in such a case as above will be explained.

Concretely, “the inter prediction parameters which are used for the generation of an inter prediction image and are multiplexed into the bitstream by the variable length encoding unit 15”, which are described in above-mentioned Embodiment 1, are changed from those shown in above-mentioned Embodiment 1 as follows.

(1) Use the same parameters as those shown in above-mentioned Embodiment 1 for the encoding of the field F₁ at the time of the encoding based on a per frame basis and at the time of the encoding based on a per field basis.

(2) Add a field F₁ pixel reference flag and a field F₁ vector reference flag to the same parameters as those shown in above-mentioned Embodiment 1 for the encoding of the field F₂ at the time of the encoding based on a per field basis. When these flags are set to ON, the field F₁ is used for reference to a pixel and reference to a prediction vector in the encoding of the field F₂. Further, when the field F₁ pixel reference flag is set to ON, the pixel reference frame specification index information and the pixel reference field specification index information are not transmitted. Similarly, when the field F₁ vector reference flag is set to ON, the vector reference frame specification index information and the vector reference field specification index information are not transmitted.

By configuring in the above-mentioned way, there is provided an advantage of reducing the code amount of the inter prediction parameters which are transmitted when the field F₂ refers to the field F.

While the invention has been described in its preferred embodiments, it is to be understood that an arbitrary combination of two or more of the above-mentioned embodiments can be made, various changes can be made in an arbitrary component in accordance with any one of the above-mentioned embodiments, and an arbitrary component in accordance with any one of the above-mentioned embodiments can be omitted within the scope of the invention.

### INDUSTRIAL APPLICABILITY

Because the video encoding device in accordance with the present invention is configured in such a way as to, when the coding unit of the coding target picture differs from that of a reference picture, correct the reference vector held by the reference picture, and derive a prediction vector from the corrected reference vector, the video encoding device can be applied to the HEVC even when the encoding based on a per frame basis and the encoding based on a per field basis coexist, and is suitable for use as a video encoding device that performs encoding of a video with a high degree of efficiency.

### EXPLANATIONS OF REFERENCE NUMERALS

1 encoding controlling unit (coding unit selector), 2 frame/field switch (coding target picture generator), 3 block partitioning unit (block partitioner), 4 select switch (prediction image generator), 5 intra prediction unit, 6 motion-compensated prediction unit (prediction image generator), 7 subtracting unit (image compressor), 8 transformation/quantization unit (image compressor), 9 inverse quantization/inverse transformation unit, 10 adding unit, 11 memory for intra prediction, 12 loop filter unit, 13 motion-compensated prediction frame memory (prediction image generator), 14 reference vector memory (prediction image generator), 15 variable length encoding unit (variable length encoder), 21 variable length decoding unit (variable length decoder), 22 select switch (prediction image generator), 23 intra prediction unit, 24 motion compensation unit (prediction image generator), 25 inverse quantization/inverse transformation unit (difference image generator), 26 adding unit (decoded image generator), 27 memory for intra prediction, 28 loop filter unit, 29 motion-compensated prediction frame memory (prediction image generator), 30 reference vector memory (prediction image generator).

1. A video encoding device comprising:
a prediction image generator that derives a prediction vector from a reference vector held by a reference picture, and also searches for a motion vector by using said prediction vector and performs a motion-compensated prediction process on a coding target picture by using said motion vector, to generate a prediction image, wherein
when a coding unit of said coding target picture differs from that of said reference picture, said prediction image generator corrects the reference vector held by said reference picture and derives the prediction vector from the corrected reference vector.

2. The video encoding device according to claim 1, wherein said prediction image generator holds said motion vector as a reference vector map of the coding target picture, and also, when the coding target picture is encoded on a per field basis, holds two reference vector maps corresponding to the coding target picture separately for fields in a frame.

3. The video encoding device according to claim 2, wherein said prediction image generator includes a variable length encoder that, when the reference picture is encoded on a per field basis and the coding target picture is encoded on a per filed basis, determines which of reference vectors in fields of a frame to which the reference picture belongs is to be used in the process of deriving the prediction vector, and also variable-length-encodes vector reference field specification index information showing whether or not the reference vector in the field having same parity as the coding target picture is used.

4. The video encoding device according to claim 1, wherein said prediction image generator is configured in such a way as to hold said motion vector as a reference vector map of the coding target picture, and also, when the coding target picture is encoded on a per field basis, hold a single reference vector map into which reference vector maps of both fields of a frame to which the coding target picture belongs are merged as a reference vector map of the frame to which the coding target picture belongs, thereby making a size of the reference vector map when the frame is encoded on a per field basis be equal to that of the reference vector map when the frame is encoded on a per frame basis.

5. The video encoding device according to claim 1, wherein said prediction image generator includes a variable length encoder that, when the coding target picture is encoded on a per field basis and is a field which is encoded second in the frame, variable-length-encodes a flag showing whether or not a field which is encoded first in the same frame is used as a reference picture.

6. A video encoding device comprising:
a coding unit selector that, for each frame which constructs an inputted image, selects either each frame or each field as a coding unit of said frame;
a coding target picture generator that generates a coding target picture having a size of the coding unit selected by said coding unit selector from each frame in said inputted image;
a block partitioner that partitions the coding target picture generated by said coding target picture generator, and outputs a coding block which is a coding target picture after the partitioning;
a prediction image generator that derives a prediction vector from a reference vector held by a reference picture, and also searches for a motion vector by using said prediction vector and performs a motion-compensated prediction process on the coding block outputted from said block partitioner by using said motion vector, to generate a prediction image;
an image compressor that compresses a difference image between the coding block outputted from said block partitioner and the prediction image generated by said prediction image generator, and outputs compressed data about said difference image; and
a variable length encoder that variable-length-encodes the compressed data outputted from said image compressor, a difference value between the motion vector searched for by said prediction image generator and the prediction vector derived by said prediction image generator, and coding unit information showing the coding unit selected by said coding unit selector, to generate a bitstream into which encoded data about said compressed data, encoded data about said difference value, and encoded data about said coding unit information are multiplexed, wherein when the coding unit of the coding target picture generated by said coding target picture generator differs from that of said reference picture, said prediction image generator corrects the reference vector held by said reference picture and derives the prediction vector from the corrected reference vector.

7. A video decoding device comprising:
a prediction image generator that derives a prediction vector from a reference vector held by a reference picture, and also adds said prediction vector and a difference value between a motion vector and a prediction vector which are multiplexed into a bitstream, decodes the motion vector, and performs a motion-compensated prediction process on a decoding target picture by using said motion vector, to generate a prediction image, wherein
when said decoding target picture and said reference picture are ones encoded on a per coding unit basis and on a per other coding unit basis, respectively, said prediction image generator corrects the reference vector held by said reference picture and derives the prediction vector from the corrected reference vector.

8. The video decoding device according to claim 7, wherein said prediction image generator stores said motion vector in a memory as a reference vector map corresponding to the decoding target picture, and also, when the decoding target picture is a one encoded on a per field basis, holds two reference vector maps corresponding to a frame to which the decoding target picture belongs separately for fields in the frame.

9. The video decoding device according to claim 8, wherein when the reference picture is a one encoded on a per field basis and the decoding target picture is a one encoded on a per filed basis, said prediction image generator switches whether a reference vector of a field having same parity of a frame to which the reference picture belongs is used on a basis of vector reference field specification index information multiplexed into the bitstream in the process of deriving the prediction vector.

10. The video decoding device according to claim 7, wherein said prediction image generator is configured in such a way as to store said motion vector in a memory as a reference vector map corresponding to the decoding target picture, and also, when the decoding target picture is a one encoded on a per field basis, hold a single reference vector map into which reference vector maps of both fields of a frame to which the decoding target picture belongs are merged as a reference vector map of the frame to which the decoding target picture belongs, thereby making a size of the reference vector map when the frame is a one encoded on a per field basis be equal to that of the reference vector map when the frame is a one encoded on a per frame basis.

11. The video decoding device according to claim 7, wherein when the decoding target picture is encoded on a per field basis and is a field which is decoded second in the frame, said prediction image generator switches whether or not a field which is decoded first in the same frame is used as a reference picture on a basis of a flag multiplexed into the bitstream and showing whether or not the field which is decoded first in the same frame is used as a reference picture.

12. A video decoding device comprising:
a variable length decoder that variable-length-decodes compressed data, a difference value, and coding unit information, which are associated with each coding block, from coded data multiplexed into a bitstream;
a prediction image generator that derives a prediction vector from a reference vector held by a reference picture, and also adds said prediction vector and the difference value variable-length-decoded by said variable length decoder, decodes the motion vector, and performs a motion-compensated prediction process on a decoding block corresponding to said coding block by using said motion vector, to generate a prediction image;
a difference image generator that generates a difference image before compression from the compressed data variable-length-decoded by said variable length decoder and associated with the coding block; and
a decoded image generator that adds the difference image generated by said difference image generator and the prediction image generated by said prediction image generator to generate a decoded image, wherein
said prediction image generator recognizes a decoding unit of a decoding target picture from the coding unit information variable-length-decoded by said variable length decoder, and, when the decoding unit of said decoding target picture differs from that of said reference picture, corrects the reference vector held by said reference picture and derives the prediction vector from the corrected reference vector.

13. A video encoding method comprising:
a prediction image generation processing step of a prediction image generator deriving a prediction vector from a reference vector held by a reference picture, also searching for a motion vector by using said prediction vector and holding said motion vector as a reference vector map of coding target picture by using said motion vector, to generate a prediction image, wherein the coding target picture by using said motion vector, to generate a prediction image, wherein in said prediction image generation processing step, when a coding unit of said coding target picture differs from that of said reference picture, the reference vector held by said reference picture is corrected and the prediction vector is derived from the corrected reference vector.

14. The video encoding method according to claim 13, wherein in said prediction image generation processing step, when the coding target picture is encoded on a per field basis, two reference vector maps corresponding to a frame to which the coding target picture belongs are held separately for fields in the frame.

15. The video encoding method according to claim 13, wherein said prediction image generation processing step includes a variable length encoding step of, when the reference picture is encoded on a per field basis and the coding target picture is encoded on a per filed basis, determining which of reference vectors in fields of a frame to which the reference picture belongs is to be used in the process of deriving the prediction vector, and variable-length-encoding vector reference field specification index information showing whether the reference vector in the field having same parity as the coding target picture is used.

16. The video encoding method according to claim 13, wherein in said prediction image generation processing step, when the coding target picture is encoded on a per field basis, a single reference vector map into which reference vector maps of both fields of a frame to which the coding target picture belongs are merged is held as a reference vector map of the frame to which the coding target picture belongs, thereby making a size of the reference vector map when the frame is encoded on a per field basis be equal to that of the reference vector map when the frame is encoded on a per frame basis.

17. The video encoding method according to claim 13, wherein in said prediction image generation processing step, a variable length encoder that, when the coding target picture is encoded on a per field basis and is a field which is encoded second in the frame, variable-length-encodes a flag showing whether or not a field which is encoded first in the same frame is used as a reference picture is provided.

18. A video decoding method comprising:
a prediction image generation processing step of a prediction image generator deriving a prediction vector from a reference vector held by a reference picture, and also adding said prediction vector and a difference value between a motion vector and a prediction vector which are multiplexed into a bitstream, decoding the motion vector and storing said motion vector in a memory as a reference vector map corresponding to a decoding target picture, and further performing a motion-compensated prediction process on the decoding target picture by using said motion vector, to generate a prediction image, wherein
in said prediction image generation processing step, when said decoding target picture and said reference picture are ones encoded on a per coding unit basis and on a per other coding unit basis, respectively, the reference vector held by said reference picture is corrected and the prediction vector is derived from the corrected reference vector.

19. The video decoding method according to claim 18, wherein in said prediction image generation processing step, when the decoding target picture is a one encoded on a per field basis, two reference vector maps corresponding to a decoding target frame are held separately for fields in the frame.

20. The video decoding method according to claim 19, wherein when the reference picture is a one encoded on a per field basis and the decoding target picture is a one encoded on a per filed basis, said prediction image generator switches whether a reference vector of a field having same parity of a frame to which the reference picture belongs or a reference vector of a field having a different parity of the frame is used on a basis of vector reference field specification index information multiplexed into the bitstream in the process of deriving the prediction vector.

21. The video decoding method according to claim 18, wherein in said prediction image generation processing step, when the decoding target picture is a one encoded on a per field basis, a single reference vector map into which reference vector maps of both fields of a frame to which the decoding target picture belongs are merged is held as a reference vector map of the frame to which the decoding target picture belongs, thereby making a size of the reference vector map when the frame is a one encoded on a per field basis be equal to that of the reference vector map when the frame is encoded on a per frame basis.

22. The video decoding method according to claim 18, wherein in said prediction image generation processing step, when the decoding target picture is encoded on a per field basis and is a field which is decoded second in the frame, whether or not a field which is decoded first in the same frame is used as a reference picture is switched on a basis of a flag multiplexed into the bitstream and showing whether or not the field which is decoded first in the same frame is used as a reference picture.
